(19) United States
(12) Patent Application Publication
(10) Pub. No.: US 2001/0034672 A1
(43) Pub. Date: Oct. 25, 2001

(54) Residential construction product management system

(76) Inventor: Thomas C. McCoy, Atlanta, GA (US)

Correspondence Address: Daniel J. Santos, Thomas, Kayden, Horstemeyer & Risley, L.L.P., Suite 1750, 100 Galleria Parkway, Atlanta, GA, 30339-5948, US

(21) Appl. No.: 09/789,168

(22) Filed: Feb. 20, 2001

Related U.S. Application Data
(60) Provisional application No. 60/183,264, filed on Feb. 17, 2000.

(51) Int. Cl. G06F 17/60

(52) U.S. Cl. 705/28; 705/11

(57) ABSTRACT

The invention is directed to a system and method for managing the selection and/or purchase of products used in residential home construction. A method of a preferred embodiment of the present invention includes maintaining a database identifying products to be used in building homes, receiving input from a builder identifying a first product to be used in building a home, receiving input from a home purchaser identifying an alternative product to be used in building the home, and providing the builder with access to data identifying the alternative product identified by the home purchaser.

An alternative embodiment of the present invention includes receiving input from a builder identifying a requirement for a product to be used in building a home, receiving input from a home purchaser identifying a product that meets the builder's requirement, and providing the builder with access to data identifying the product identified by the home purchaser.

### CLAIM OF PRIORITY

This application claims priority to copending U.S. provisional application entitled “New Home Allowance Upgrade Calculator” having Ser. No. 60/183,264 filed on Feb. 17, 2000, which is hereby entirely incorporated herein by reference.

### TECHNICAL FIELD

The present invention is generally related to the field of home construction and, more particularly, is related to a system and method for selecting products used in the construction of a new home.

### BACKGROUND OF THE INVENTION

Traditionally, when a builder of residential homes enters into a contract for the sale of a home that is under construction, the builder provides the purchaser of the home with a list of the builder allowances that are included in the price of the home. A builder often uses a fixed dollar amount for the allowances. Some builders determine what products will be included in the allowances, some let the home purchasers choose the products, and others choose some of the products while letting purchasers choose the remaining items. In most circumstances, regardless of whether the builder has chosen some or all of the products in the allowances, the home purchaser insists or expects to be able to choose some products and/or to upgrade some of the choices that the builder has made.

The traditional process by which a home purchaser chooses or upgrades products that will be used by the builder in constructing a home is often time consuming and prone to errors. For example, a builder may select an appliance to be used in a new home and may identify it by its model number, dimensions, and possibly by its color. If the home purchaser wishes to upgrade or change the builder's selection, the builder would likely instruct the home purchaser to go to a certain retail store. However, once a home purchaser arrives at the retail store, the home purchaser may not know in advance what selections may be acceptable; the builder may have certain requirements or parameters for the products that the builder intends to use in building the home. The retailer may or may not be able to provide such information to the home purchaser depending on whether the information was provided to the retailer and on whether a retailer's employee is able to locate such information.

A home purchaser may have to visit several retailers in order to make product selections and/or upgrades for various products. After a home purchaser goes to a designated retailer and makes a selection, the retailer often makes a note of the home purchaser's selections and passes the information to the builder. The builder then typically passes the information to a sales agent that amends a home purchase contract to reflect any obligations incurred by the builder and purchaser in connection with the new product selections and/or upgrades. Sometime product selections and/or upgrades along with associated costs are not communicated to a sales agent. Therefore, when the sales agent creates a contract amendment, pertinent information is often left out thereby resulting in one of the parties being overcharged.

One of the problems with the above approach is that a home purchaser may have to pay for all of the upgrades up front (which can add up to thousands of dollars). The home purchaser may not be reimbursed for his upgrade expenditures until the home closing. Another problem is that builders often give purchasers information about allowance amounts and the home purchasers are left with the task of selecting various products with little guidance from the builder. Therefore, a home purchaser may end up selecting an item, such as a gas cooktop or an up-draft cooking ventilation system only to discover that the builder had planned for and would only be using an electric cooktop with a down draft ventilation system. Unsatisfactory selections by a home purchaser may be the result of a lack of communication, poor communication, or miscommunication between the builder, the home purchaser, and/or a retailer.

A home purchaser may end up having to go back to retailers several times because products that the home purchaser had selected were unsatisfactory to the builder. Not only would this consume a significant amount of the home purchaser's time but it could also delay the construction of the new home. Construction delays can be costly to the builder due to the time value of money; a delay in construction typically results in a delay in the closing thereby resulting in the builder paying interest expense on the home during the delay period. Therefore there exists a need for a system and method that make the process of selecting and purchasing products for new home construction easier, faster, and more efficient.

### SUMMARY OF THE INVENTION

The invention is directed to a system and method for managing the selection and/or purchase of products used in residential home construction. A method of a preferred embodiment of the present invention includes maintaining a database identifying products to be used in building homes, receiving input from a builder identifying a first product to be used in building a home, receiving input from a home purchaser identifying an alternative product to be used in building the home, and providing the builder with access to data identifying the alternative product identified by the home purchaser.

An alternative embodiment of the present invention includes receiving input from a builder identifying a requirement for a product to be used in building a home, receiving input from a home purchaser identifying a product that meets the builder's requirement, and providing the builder with access to data identifying the product identified by the home purchaser.

### BRIEF DESCRIPTION OF THE DRAWINGS

FIG. 1 is An example of a general purpose computer that can implement the residential construction product management (RCPM) system of the present invention.

FIG. 2 is a block diagram that depicts a non-limiting example a communications system that can be used to implement an embodiment of the present invention.

FIG. 3A is a non limiting example of a flow-chart depicting steps that are implemented by the RCPM system of the present invention.

FIG. 3B is a non limiting example of a flow-chart depicting an alternative embodiment to the flow chart shown in FIG. 3A.

FIG. 4 illustrates a non-limiting example of a Home Page that is presented to a user that accesses a web site of this invention.

FIG. 5 illustrates a non-limiting example of a Merchant Login page that is presented to a merchant that selects the “MerchantNet” option shown in FIG.4.

FIG. 6 illustrates a non-limiting example of a Merchant Services web page that is presented to a merchant that logs into the RCPM system using a valid user ID and password combination.

FIG. 7 illustrates a non-limiting example of an Active Orders web page that is presented to a merchant that selects the “active product orders” option while being presented with the Merchant Services web page shown in FIG.6.

FIG. 8 illustrates a non-limiting example of an Active Order Confirmation web page that is presented to a merchant that selects an address from the active orders address list shown in FIG.7.

FIG. 9 illustrates a non-limiting example of a Product Purchase Dates web page that is presented to a merchant after the merchant selects a “product purchase dates” option from a merchant web page such as the active order confirmation web page.

FIG. 10 illustrates a non-limiting example of an MPO Control Panel web page that is provided to a merchant after the merchant selects an MPO control panel option from a merchant web page such as product purchase dates web page.

FIG. 11 illustrates a non-limiting example of an MPO Addition web page that is provided to a merchant after the merchant selects the “Add MPO” option while being presented with the MPO control panel web page.

FIG. 12 illustrates a non-limiting example of a Product Placement web page that is provided to a merchant after the merchant creates an MPO by via the MPO addition web page shown in FIG. 11.

FIG. 13 illustrates a non-limiting example of a Package Coupons web page that is presented to a merchant that selects the package coupons option from a merchant web page such as, for example, a product placement web page shown in FIG. 12.

FIG. 14 illustrates a non-limiting example of a Consumer Coupons web page that is presented to a merchant that selects the consumer coupons option from a merchant web page such as, for example, the package coupons web page shown in FIG. 13.

FIG. 15 illustrates a non-limiting example of a Product Advantage web page that is presented to a merchant that selects the product advantage option from a merchant web page such as, for example, the consumer coupons web page shown in FIG. 14.

FIG. 16 illustrates a non-limiting example of an “ENotification” web page that is presented to a merchant that selects the product advantage option from a merchant web page such as, for example, the Product Advantage web page shown in FIG. 15.

FIG. 17 illustrates a non-limiting example of a Sales Statistics web page that can be requested by a merchant by selecting a corresponding hyperlink from a merchant web page, such as, for example, the ENotification web page shown in FIG. 16.

FIG. 18 illustrates a non-limiting example of a Ranking Status web page that can be requested by a merchant by selecting a corresponding hyperlink from a merchant web page, such as, for example, the ENotification web page shown in FIG. 16.

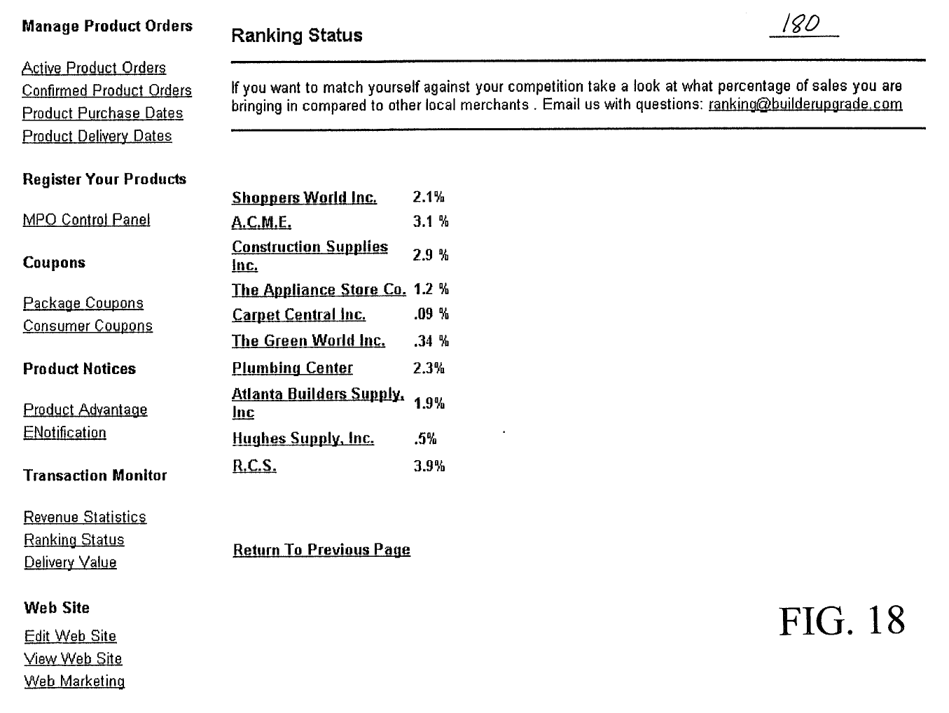

FIG. 19 illustrates a non-limiting example of a Delivery Value web page that can be requested by a merchant by selecting a corresponding hyperlink from a merchant web page, such as, for example, the ENotification web page shown in FIG. 16.

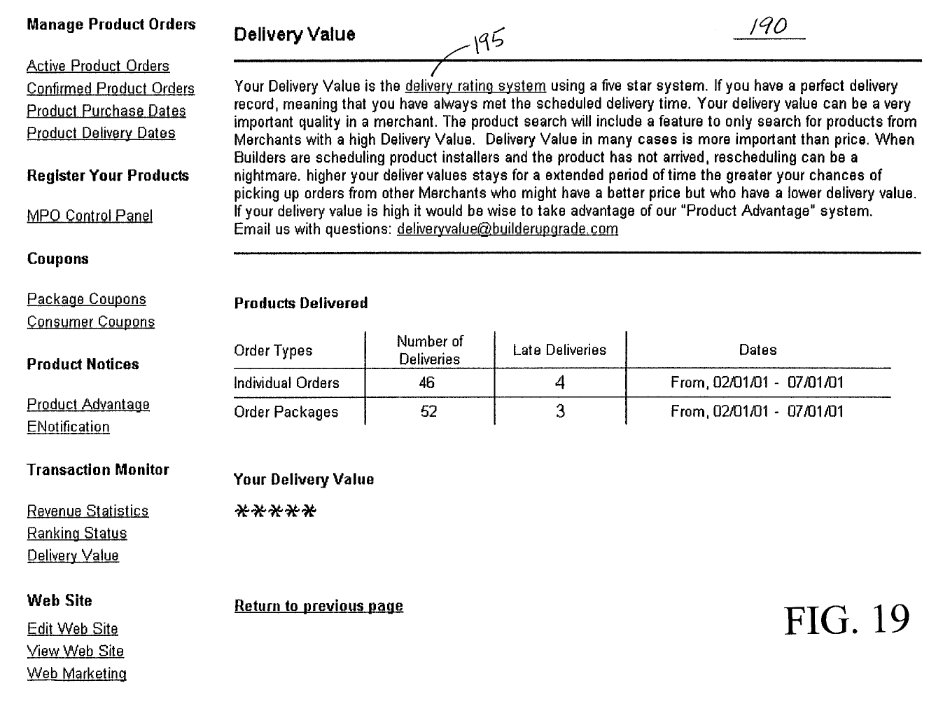

FIG.20 illustrates a non-limiting example of a Delivery Value Rating System web page that provides information on the standards that are used to derive delivery value ratings.

FIG. 21 illustrates a non-limiting example of a Merchant Company Page that is presented to a merchant that selects the “edit web site” option from a merchant web page such as, for example, the Delivery Value Rating System web page shown in FIG. 20.

FIG. 22 illustrates a non-limiting example of a promotional web page that contains hyperlinks that can be used to access additional information about a merchant and/or a merchant's product offerings.

FIG. 23 illustrates a non-limiting example of a Web Marketing web page that is presented to a merchant that selects the web marketing option from a merchant web page such as, for example, the Delivery Value Rating System web page shown in FIG. 20.

FIG. 24 illustrates a non-limiting example of a Builder Login web page that is presented to a builder that selects the “Builder” option shown in FIG.4.

FIG. 25 illustrates a non-limiting example of a Builder Services web page that is presented to a builder that logs into the RCPM system using a valid RCPM ID and password combination.

FIG. 26 illustrates a non-limiting example of a New Home Accounts Database web page that is presented to a builder that selects the “open new home account” option while being presented with the Builder Services web page shown in FIG. 25.

FIG. 27 illustrates a non-limiting example of an Address Information web page that is presented to a builder that selects the proceed option while being presented with the New Home Accounts Database web page shown in FIG. 26.

FIG. 28 illustrates a non-limiting example of an Information Dispersal Control Panel web page that is presented to a builder that selects the Create Account option while being presented with the an Address Information web page shown in FIG. 27.

FIG. 29 illustrates a non-limiting example of a Profile Selection web page that is presented to a builder that selects the Allowance Profiles option while being presented with the Information Dispersal Control Panel web page shown in FIG. 28.

FIG. 30 illustrates a non-limiting example of a New Active Profile web page that is presented to a builder that selects option while being presented with the Profile Selection web page shown in FIG. 29.

FIG. 31 illustrates a non-limiting example of an Appliance Selection web page that is presented to a builder that selects the Appliances option while being presented with the New Active Profile web page shown in FIG. 30.

FIG. 32 illustrates a non-limiting example of a Cooktop Search web page that is presented to a builder that selects the Cooktop option while being presented with the Appliance Selection web page shown in FIG. 31.

FIG. 33 illustrates a non-limiting example of a Cooktop Listing web page that is presented to a builder that selects the Brand option while being presented with the Cooktop Search web page shown in FIG. 32.

FIG. 34 illustrates a non-limiting example of a Cooktop Information web page that is presented to a builder that selects the “JP930WAWW” cooktop hyperlink while being presented with the Cooktop Listing web page shown in FIG. 33.

FIG. 35 illustrates a non-limiting example of a Selection Confirmation web page that is presented to a builder that places an order for an item via an item selection web page.

FIG. 36 illustrates a non-limiting example of an Appliance Profile web page that is presented to a builder that selects the “Add Product To Profile” option while being presented with the Selection Confirmation web page shown in FIG. 35.

FIG. 37 illustrates a non-limiting example of an Active Profile web page that is presented to a builder that selects the “View Entire Profile” option while being presented with the Appliance Profile web page shown in FIG. 36.

FIG. 38 illustrates a non-limiting example of a Home Purchaser Login web page that is presented to a home purchaser that selects the “Home purchaser” option while being presented with an RCPM web page, such as, for example, home page shown in FIG.4.

FIG. 39 illustrates a non-limiting example of a Home Purchaser Services web page that is presented to a home purchaser that logs into the RCPM system using a valid RCPM ID and password combination.

FIG. 40 illustrates a non-limiting example of an Appliance Selection web page that is presented to a home purchaser that selects the “Appliances” option while being presented with the Home Purchaser Services web page shown in FIG.39.

FIG. 41 illustrates a non-limiting example of a Cooktop Upgrade web page that is presented to a home purchaser that selects the “Cooktop” option while being presented with Appliance Selection web page shown in FIG.40.

FIG. 42 illustrates a non-limiting example of a scrolled down version of the cooktop Upgrade web page shown in FIG. 42.

FIG. 43 illustrates a non-limiting example of a Cooktop Information web page that is presented to a home purchaser that selects the cooktop hyperlink while being presented with the Cooktop Upgrade web page shown in FIG.42.

FIG. 44 illustrates a non-limiting example of an Upgrade Confirmation web page that is presented to a home purchaser that selects the “Upgrade” option while being presented with the Cooktop Upgrade web page shown in FIG.42.

FIG. 45 illustrates a non-limiting example of a Profile Confirmation Web Page that is presented to a home purchaser that selects the “Upgrade Appliances” option while being presented with the Upgrade Confirmation web page shown in FIG.44.

FIG. 46 illustrates a non-limiting example of a Profile Manager web page that is presented to a builder that selects the “Profile Manager” option while being presented with the Builder Services web page shown in FIG. 25.

FIG. 47 illustrates a non-limiting example of a Selected Allowance Profiles web page that is presented to a builder that selects the “Selected Profiles” hyperlink while being presented with the Profile Manager web page shown in FIG. 46.

FIG. 48 illustrates a non-limiting example of a Selected Profile web page that is presented to a builder that selects the “10 Rivers Edge Road” hyperlink while being presented with the Selected Allowance Profiles web page shown in FIG. 47.

FIG. 49 illustrates a non-limiting example of a Purchase web page that is presented to a builder that selects the “Purchase Upgrades” option while being presented with the Selected Profile web page shown in FIG. 48.

FIG. 50 illustrates a non-limiting example of a Purchase Dates web page that is presented to a builder that selects the Purchase Date option while being presented with the Purchase web page shown in FIG. 49.

FIG. 51 illustrates a non-limiting example of a Delivery Dates web page that is presented to a builder that selects the Delivery Date option while being presented with the Purchase web page shown in FIG. 49.

FIG. 52 illustrates a non-limiting example of an EConfirmation web page that is presented to a builder that selects the Email Setup option while being presented with the Delivery Dates web page shown in FIG. 51.

FIG. 53 illustrates a non-limiting example of a Property Selection web page that is presented to a builder that selects the “Detailed Home Info.” option while being presented with a builder web page, such as, for example, the Information Dispersal Control Panel web page shown in FIG. 28.

FIG. 54A illustrates a non-limiting example of a Web-Brochure Construction web page that is presented to a builder that selects the proceed option while being presented with the Property Selection web page shown in FIG. 53.

FIG. 54B illustrates a non-limiting example of a scrolled down version of the Web-Brochure Construction web page shown in FIG. 54A.

FIG. 55 illustrates a non-limiting example of an Image Upload web page that is presented to a builder that selects the current image of the home while being presented with the Web-Brochure Construction web page shown in FIG. 54A.

FIG. 56 illustrates a non-limiting example of a scrolled down version of the Image Upload web page shown in FIG. 55.

FIG. 57 illustrates a non-limiting example of a Home Marketing web page that is constructed by a builder using one or more construction web pages.

### DETAILED DESCRIPTION OF PREFERRED EMBODIMENTS

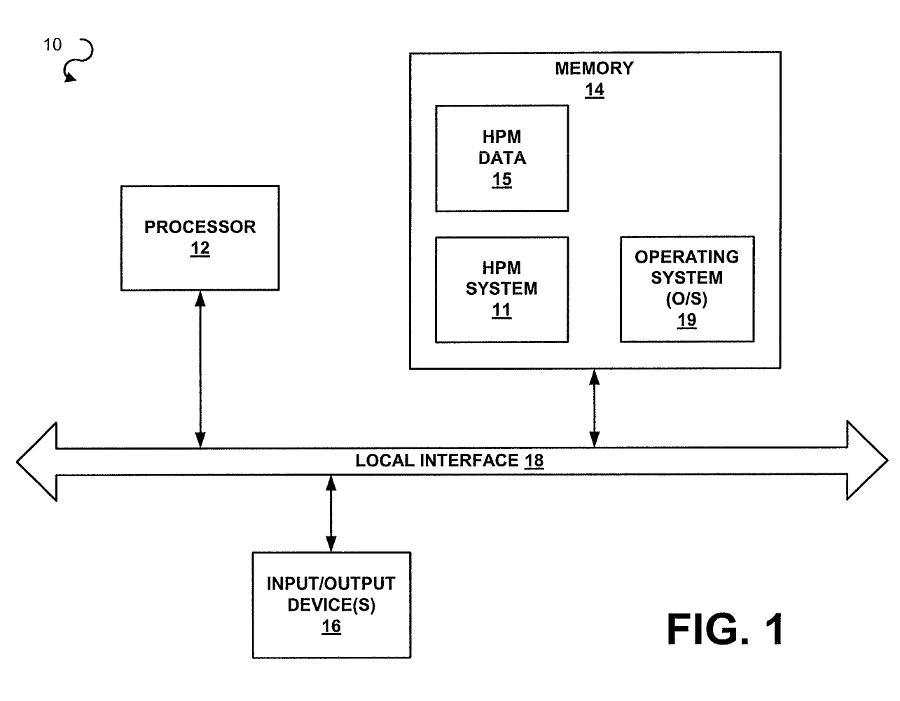

The residential construction product management (RCPM) system 11 of the invention can be implemented in software (e.g., firmware), hardware, or a combination thereof. In the currently contemplated best mode, the RCPM system 11 is implemented in software, as an executable program, and is executed by a special or general purpose digital computer, such as a personal computer (PC; IBM-compatible, Apple-compatible, or otherwise), workstation, minicomputer, or mainframe computer. An example of a general purpose computer that can implement the RCPM system 11 of the present invention is shown in FIG. 1.

Generally, in terms of hardware architecture, as shown in FIG. 1, the RCPM computer 10 includes a processor 12, memory 14, and one or more input and/or output (I/O) devices 16 (or peripherals) that are communicatively coupled via a local interface 18. The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 12 is a hardware device for executing software that can be stored in memory 14. The processor 12 can be any custom made or commercially available processor, a central processing unit (CPU) or an auxiliary processor among several processors associated with the RCPM computer 10, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 14 can include any one or a combination of volatile memory elements (e.g., random access memory (RAM, such as DRAM, SRAM, etc.)) and nonvolatile memory elements (e.g., ROM, hard drive, tape, CDROM, etc.). Moreover, the memory 14 may incorporate electronic, magnetic, optical, and/or other types of storage media. Note that the memory 14 can have a distributed architecture, where various components are situated remote from one another, but can be accessed by the processor 12.

The software in memory 14 may include one or more separate programs, each of which comprises an ordered listing of executable instructions for implementing logical functions. In the example of FIG. 1, the software in the memory 14 includes the RCPM system 11 and a suitable operating system (O/S) 19. A non-exhaustive list of examples of suitable commercially available operating systems 19 is as follows: a Windows operating system from Microsoft Corporation, U.S.A., a NetWare operating system available from Novell, Inc., U.S.A., or a UNIX operating system, which is available for purchase from many vendors, such as Sun Microsystems, Inc., Hewlett-Packard Company, U.S.A., and AT&T Corporation, U.S.A. The operating system 19 essentially controls the execution of other computer programs, such as the RCPM system 11, and provides scheduling, input-output control, file and data management, memory management, and communication control and related services.

The RCPM system 11 is a source program, executable program (object code), script, or any other entity comprising a set of instructions to be performed. When the RCPM system 11 is a source program, then the program needs to be translated via a compiler, assembler, interpreter, or the like, which may or may not be included within the memory 14, so as to operate properly in connection with the O/S 19. Furthermore, the RCPM system 11 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The RCPM data 15 is data that is stored by the RCPM system 11 in memory 14 and contains information related to RCPM products and RCPM participants (builders, merchants, and purchasers). In an alternative embodiment the RCPM data 15 is stored in a memory device (not shown) that is coupled to the RCPM computer 10 via an output/input device 16.

The I/O devices 16 may include input devices, for example but not limited to, a keyboard, mouse, scanner, microphone, etc. Furthermore, the I/O devices 16 may also include output devices, for example but not limited to, a printer, display, etc. Finally, the I/O devices 16 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the RCPM computer 10 is a PC, workstation, or the like, the software in the memory 14 may further include a basic input output system (BIOS) (omitted for simplicity). The BIOS is a set of essential software routines that initialize and test hardware at startup, start the O/S 19, and support the transfer of data among the hardware devices. The BIOS is stored in ROM so that the BIOS can be executed when the RCPM computer 10 is activated.

When the RCPM computer 10 is in operation, the processor 12 is configured to execute software stored within the memory 14, to communicate data to and from the memory 14, and to generally control operations of the RCPM computer 10 pursuant to the software. The RCPM system 11 and the O/S 19, in whole or in part, but typically the latter, are read by the processor 12, perhaps buffered within the processor 12, and then executed.

When the RCPM system 11 is implemented in software, as is shown in FIG. 1, it can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The RCPM system 11 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the RCPM system 11 is implemented in hardware, the RCPM system 11 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

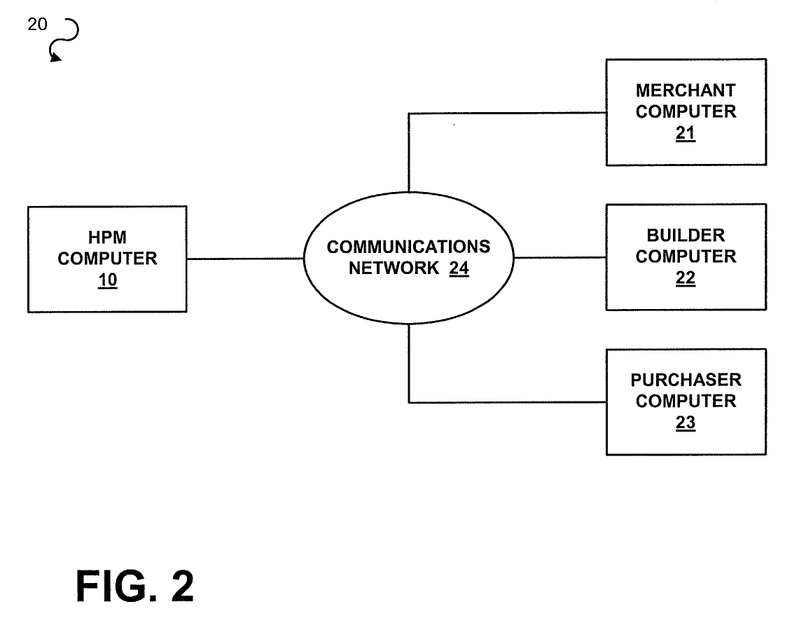

FIG. 2 is a block diagram that depicts a non-limiting example of a communications system 20 that can be used to implement an embodiment of the present invention. The communications system 20 includes a RCPM computer 10, a merchant computer 21, a builder computer 22, and a purchaser computer 23 that are coupled to a communications network 24. In one embodiment, the communications system 20 also includes a real estate agent computer (not shown). The communications network 24 may be the internet, a public switched telephone network (PSTN), an asynchronous transfer mode (ATM) network, a wireless network, or any other suitable means of communication. The merchant computer 21, the builder computer 22, and the purchaser computer 23, are used by a merchant, a builder, and a home purchaser respectively, and may each be a special or a general purpose digital computer, such as a personal computer (PC; IBM-compatible, Apple-compatible, or otherwise), a workstation, a minicomputer, or a mainframe computer.

In a preferred embodiment of the invention, the communications network 24 is the internet and the RCPM computer 10 receives hyper text transfer protocol (http) messages from one or more of the other computers 21-23, and responds by transmitting hyper text markup language (html) data. The communications language and protocol used, however, are not limited to html and http, and may be any other suitable communications language and protocol.

In an alternative embodiment, the RCPM computer 10 communicates with a merchant computer 21, a builder computer 22, and a purchaser computer 23, via different communication means. As a non-limiting example, the RCPM computer 10 may communicate with a merchant computer 21 via a private communications link and may communicate with a builder computer 22, and a purchaser computer 23 via the internet.

In another alternative embodiment, the communications system 20 does not include one or more of the computers 21, 22, and 23. In this alternative embodiment, communications with a participant (merchant, builder, or purchaser) may be achieved via an alternative communications means, such as, for example via a telephone, a facsimile transmission, the Postal Service, or a courier, whereby information received from a participant is entered into the RCPM computer 10 by an RCPM system operator, and information transmitted to a participant is retrieved from the RCPM computer 10 by an RCPM system operator.

In yet another alternative embodiment, the communications system 20 does in fact include the computers 21, 22, and 23, but communications with one or more participants (merchants, builders, and/or purchasers) may be achieved via an alternative communications means as discussed above.

For illustrative purposes, only one RCPM computer 10, one merchant computer 21, one builder computer 22, and one purchaser computer 23 are shown. However, the communications system 20 can include more than one of each of the above computers.

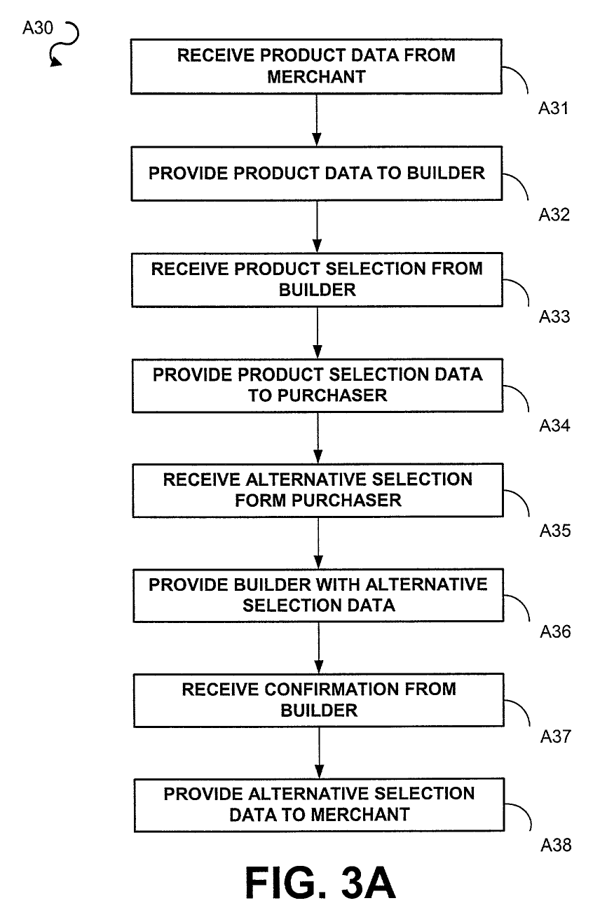

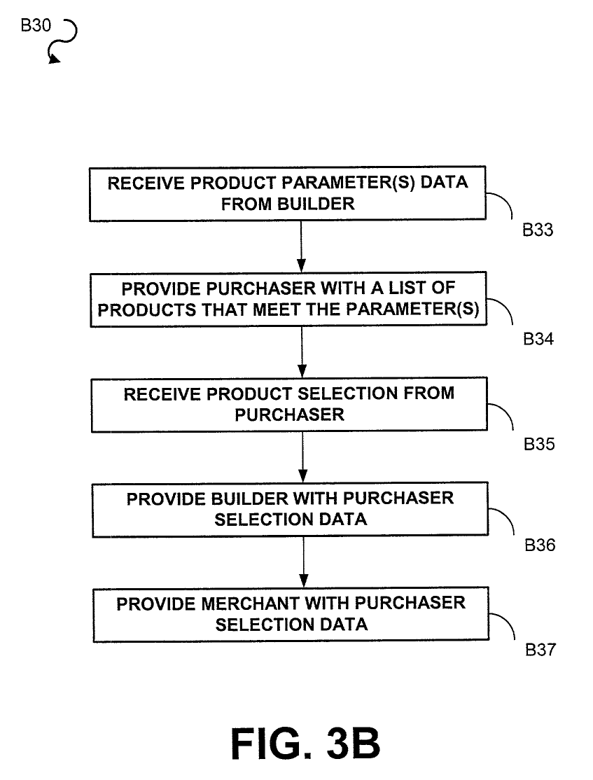

FIG. 3A is a non-limiting example of a flow-chart A30 depicting steps that are implemented by the RCPM system 11 of the present invention. Flow chart A30 depicts a method for facilitating the purchase and/or upgrade of one or more products that are used in the construction of residential structures such as, for example, houses, condominiums, villas, and apartments. As a non-limiting example, types of such products may include appliances, lighting, flooring, landscaping, plumbing, counter tops, tile, marble, paint, wallpaper, interior trim, and exterior facade.

The RCPM system 11 receives product data from a merchant as indicated in block A31, and stores the data in memory 14. The product data may include a product identification number, a product price, or a product description, and may be received directly from a merchant computer 21 or may be entered by an RCPM system operator into memory 14 based on data received from a merchant. Typically, a merchant will provide data about multiple products as will be discussed further below.

The RCPM system 11 then provides product data to a builder as indicated in block A32. The product data provided in block 32 includes some or all of the data that is received in block A31. Typically, information about many products is provided to a builder as will be discussed further below. The RCPM system 11 then receives a product selection from a builder as indicated in block A33 and stores data corresponding to the product selection in memory 14. The product selection provided by the builder is typically associated with a property location, as discussed further below, and is provided to a home purchaser as indicated in block A34. If the home purchaser desires to select an alternative product, then the home purchaser may do so as indicated in block A35. The home purchaser is also typically provided with the cost associated with making an alternative selection, as discussed further below. The RCPM system 11 then provides the builder with information about the home purchaser's alternative selection, receives a confirmation from the builder, and provides information about the final product selection to the merchant as indicated in blocks A36, A37, and A38, respectively.

In alternative embodiments, one or more steps may be eliminated. As a non-limiting example, step A37 may be eliminated such that final selection data is provided to a merchant without the need to receive a prior confirmation from the builder. As another non-limiting example, step A31 is eliminated such that a merchant may agree to fulfill a builder or purchaser selection at a pre-determined price without having provided any prior product data to the RCPM system 11.

FIG. 3B is a non-limiting example of a flow-chart B30 depicting an alternative embodiment to the flow chart A30 illustrated in FIG. 3A. The RCPM system 11 receives product parameter(s) data from a builder specifying requirements for, or limitations on a type or number of units of a product that the builder intends to use in constructing a residential structure as indicated in block B33. The RCPM system 11 then provides a home purchaser with a list of one or more products that meet the builder specified parameter(s), and receives a product selection from the home purchaser as indicated in blocks B34 and B35 respectively. The product selection corresponds to a product that is identified in the list provided to the home purchaser by the RCPM system 11. The RCPM system 11 then provides the builder and the merchant with product selection data corresponding to the home purchaser's selection as indicated in blocks B36 and B37 respectively.

In an alternative embodiment to the method illustrated in FIG. 3B, the step represented by block B34 may be eliminated and replaced with the step of providing the home purchaser with product parameter(s) data that the home purchaser may then use in making product selection(s).

The flow chart of FIGS. 3A and 3B show the functionality of possible implementations of RCPM system 11. In this regard, each block represents a module, segment, or portion of code, which comprises one or more executable instructions for implementing the specified logical function(s). It should also be noted that in some alternative implementations, the functions noted in the blocks may occur out of the order noted in FIGS. 3A and 3B. As a non-limiting example, blocks B36 and B37 may be executed substantially concurrently or in reverse order.

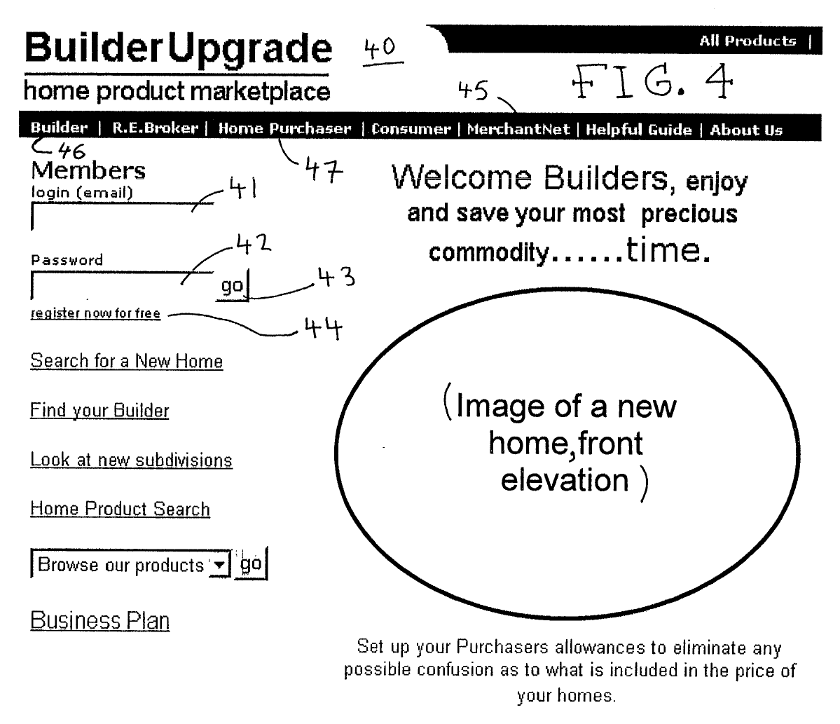

FIG. 4 illustrates a non-limiting example of a Home Page 40 that is presented to a user that accesses a web site of this invention. A user that had previously registered with the RCPM system 11 can login by entering the registered user ID in the ID field 41 and the corresponding registered password in the password field 42 and by then selecting the “go” option 43. After a user logs in, the user is presented with a web page that corresponds to the user's designation (e.g. merchant) and that contains hyperlinks to information pertinent the user. A user that had not previously registered with the RCPM system 11 may select the “register” option 44 in order to access a registration web page.

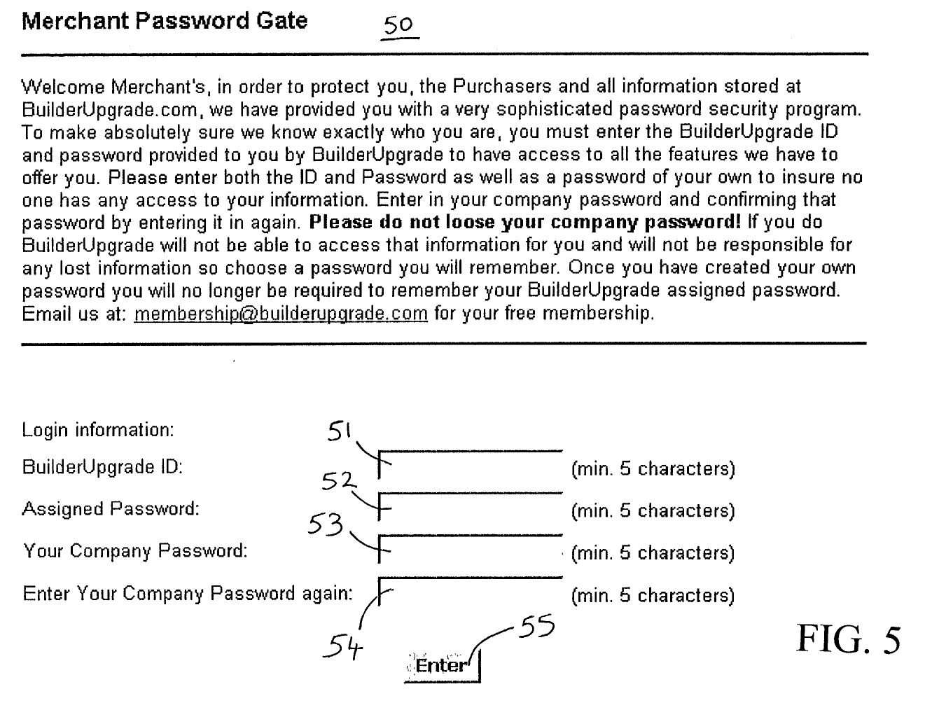

FIG. 5 illustrates a non-limiting example of a Merchant Login web page 50 that is presented to a merchant that selects the “MerchantNet” option 45 (FIG.4). A merchant that had previously registered with the RCPM system 11 can login by entering the merchant's assigned RCPM ID, a corresponding assigned password, and a company password in the fields 51, 52, and 53 respectively. Then, after re-entering the company password in field 54 a merchant can complete the login process by selecting the “enter” option 55.

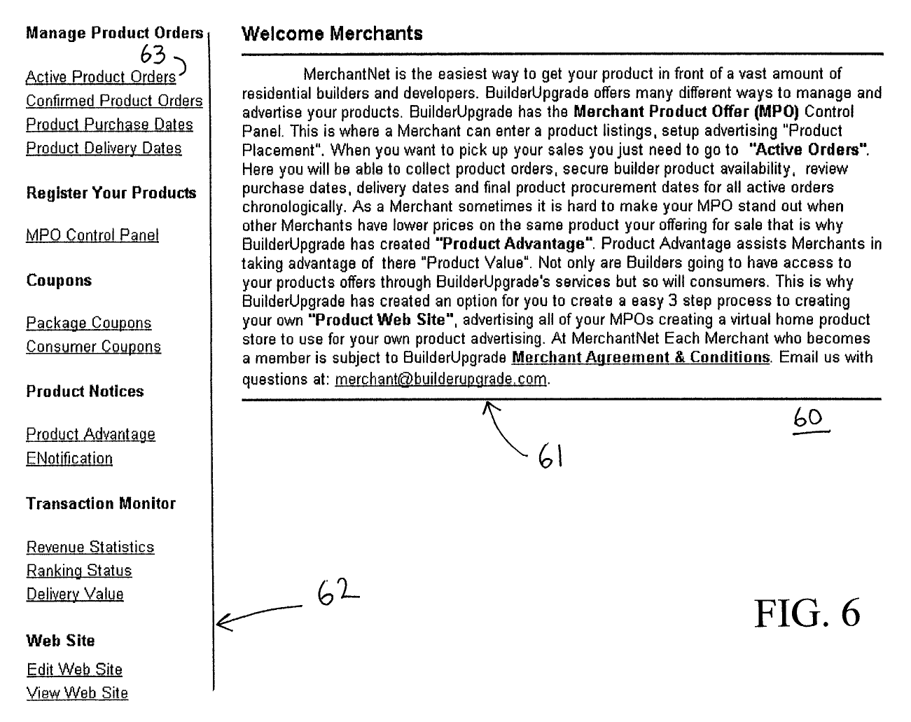

FIG. 6 illustrates a non-limiting example of a Merchant Services web page 60 that is presented to a merchant that logs into the RCPM system 11 using a valid user ID and password combination. The merchant information section 61 contains information about services that RCPM offers to merchants. The left hand portion 62 of the web page contains hyperlinks to other web pages containing information relevant to the merchant.

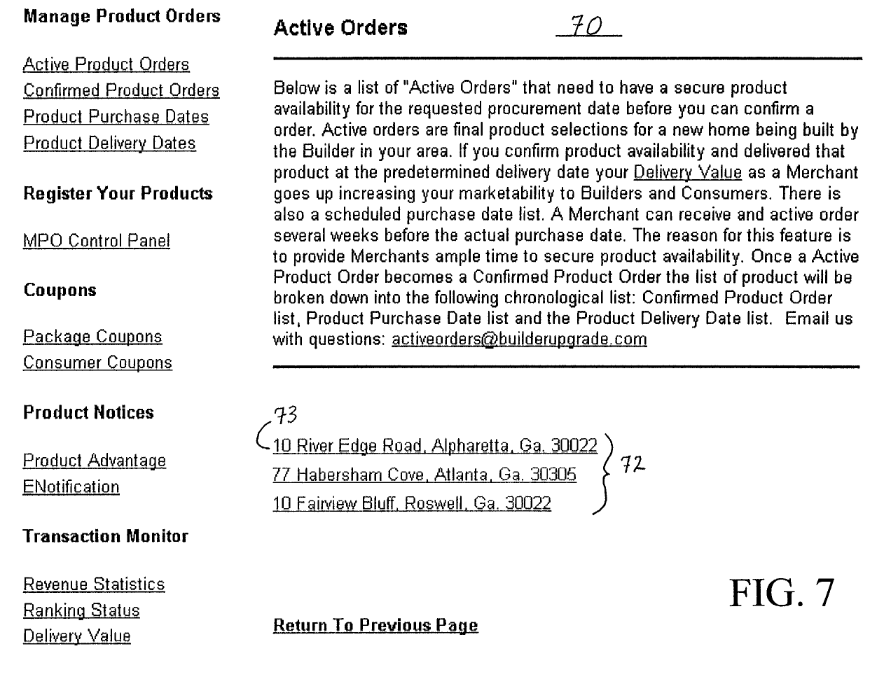

FIG. 7 illustrates a non-limiting example of an Active Orders web page 70 that is presented to a merchant that selects the “active product orders” option 63 while being presented with the Merchant Services web page 60 (FIG.6). The active orders web page 70 includes an active orders address list 72 of active product orders for the merchant. Active orders are final product selections for a new home being built by a builder.

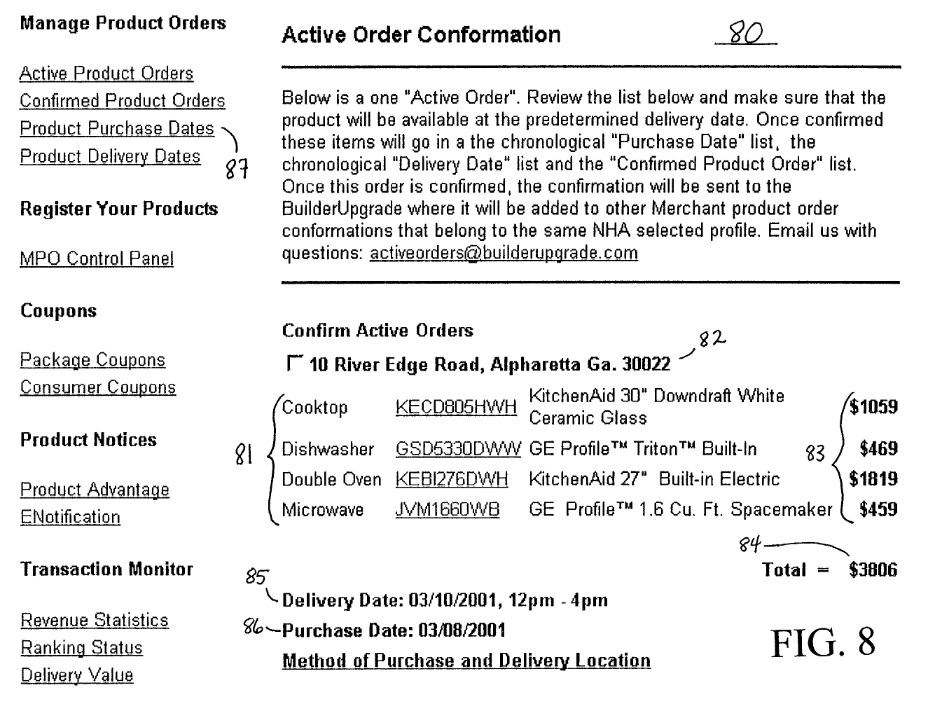

FIG. 8 illustrates a non-limiting example of an Active Order Confirmation web page 80 that is presented to a merchant that selects an address 73 (FIG.7) from the active orders address list 72. The active order confirmation web page 80 includes a list of active orders 81 for the selected address 82. In this example, the active orders correspond to a cooktop, a dishwasher, an electric oven, and a microwave oven. The list of active orders 81 includes itemized prices 83, a total price 84, a delivery date 85, and a purchase date 86.

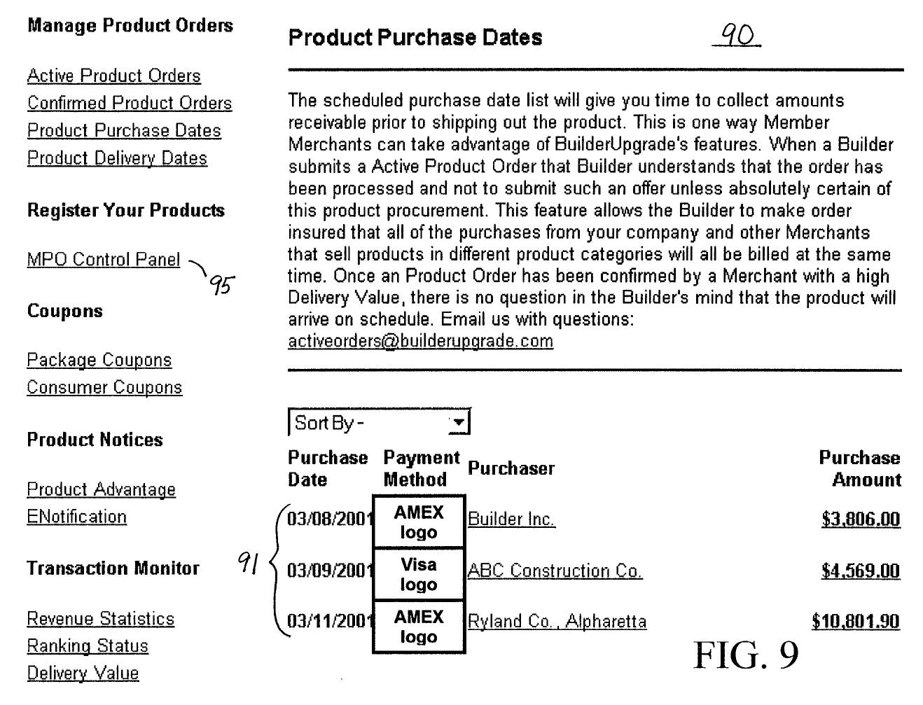

FIG. 9 illustrates a non-limiting example of a Product Purchase Dates web page 90 that is presented to a merchant after the merchant selects a “product purchase dates” option 87 from a merchant web page such as the active order confirmation web page 80. The product purchase dates web page 90 provides a merchant with a transaction list 91 that identifies “purchasers” (which in this case are builders) along with respective purchase dates, payment methods, and purchase amounts.

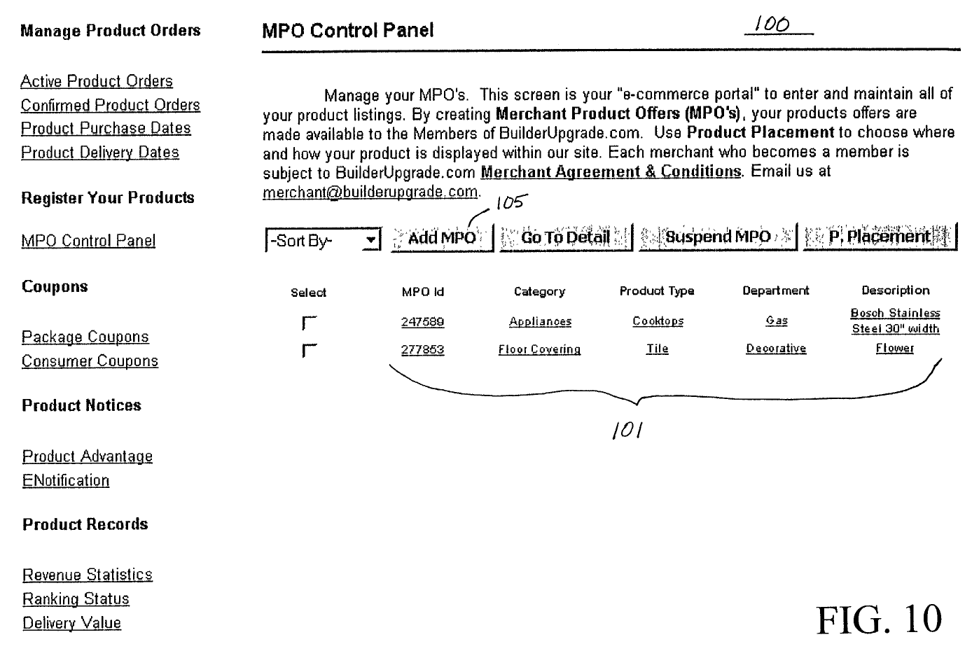

FIG. 10 illustrates a non-limiting example of an MPO Control Panel web page 100 that is provided to a merchant after the merchant selects an “MPO control panel” option 95 from a merchant web page such as the Product Purchase Dates web page 90 (FIG. 9). An MPO list 101 identifies products currently offered by the merchant and includes information such as MPO identification numbers along with respective categories, product types, product departments, and product descriptions.

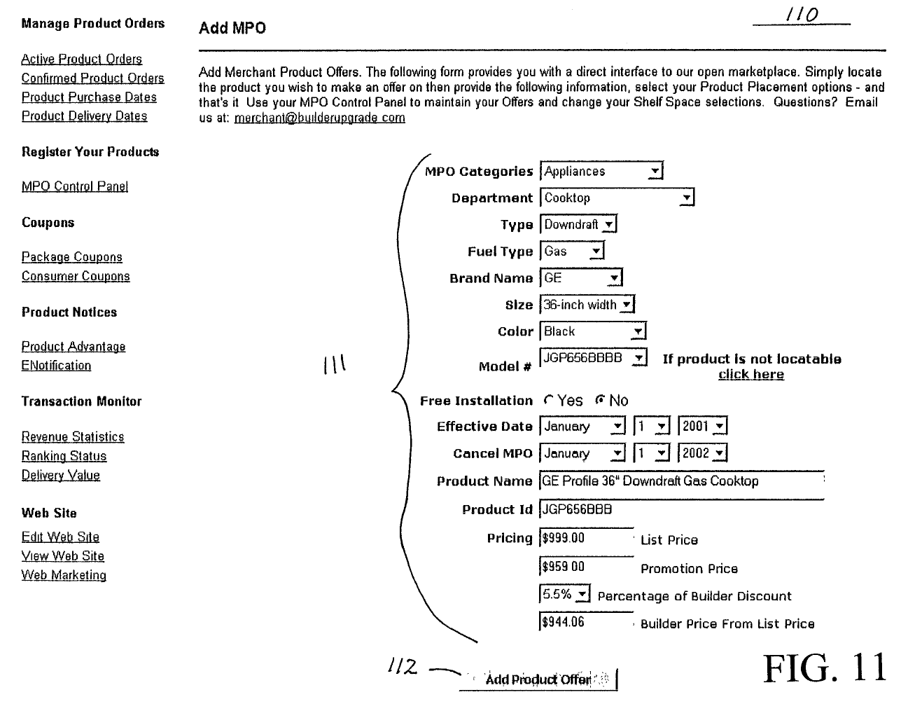

FIG. 11 illustrates a non-limiting example of an MPO Addition web page 110 that is provided to a merchant after the merchant selects the “Add MPO” option 105 while being presented with the MPO control panel web page 100. MPO addition web page 110 can be used by a merchant to create an MPO by entering information about the MPO in the MPO entry fields 111, and by then selecting the “Add Product Offer” option 112.

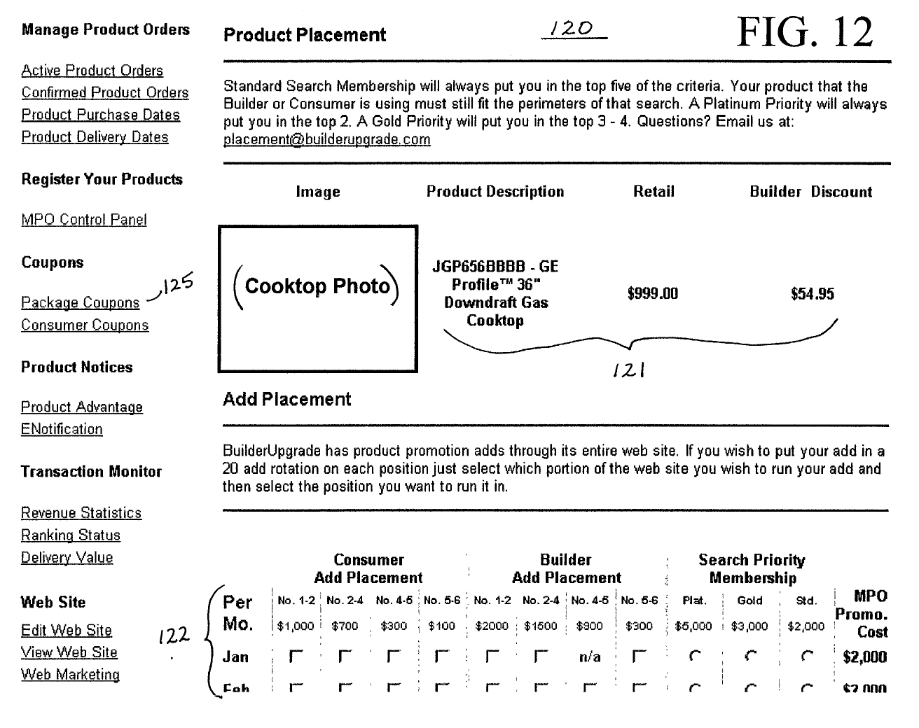

FIG. 12 illustrates a non-limiting example of a Product Placement web page 120 that is provided to a merchant after the merchant creates an MPO via the MPO addition web page 110 (FIG. 11). The product placement web page 120 provides MPO confirmation information 121 and product promotion options 122. The MPO confirmation information 121 includes a product description, a retail price for the product, and the amount of the builder discount. The product promotion options 122 can be used by a merchant to promote his recent MPO (which in this case is a downdraft gas cooktop). The RCPM offers product promotion advertisements throughout many of its web pages. A merchant can request (via the product promotion options 122) that advertisements be placed for the merchant's product on RCPM web pages by selecting a desired time period, location and position for the advertisements.

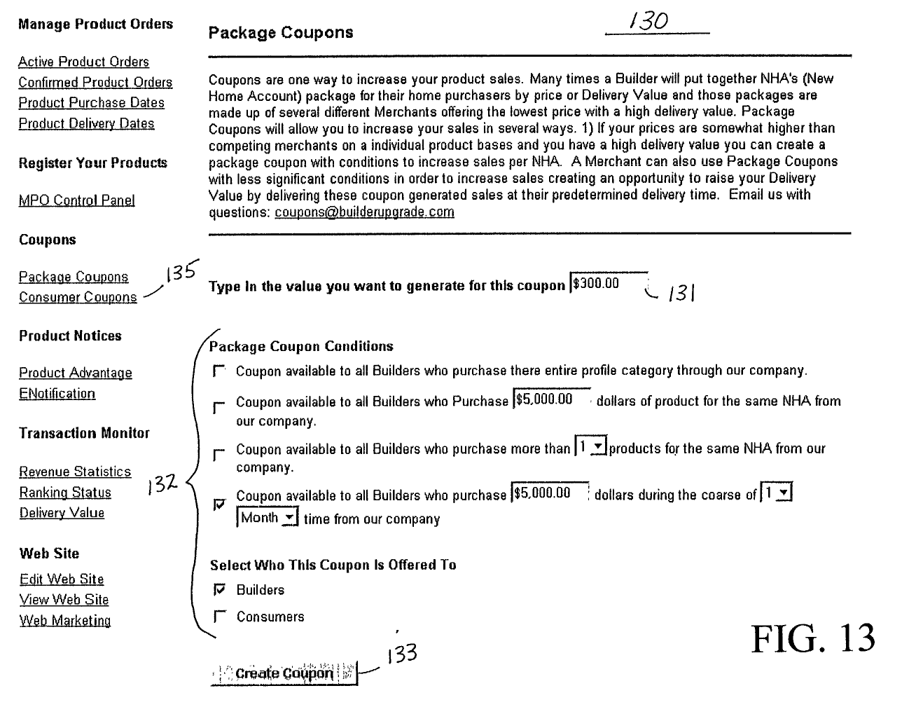

FIG. 13 illustrates a non-limiting example of a Package Coupons web page 130 that is presented to a merchant that selects the “package coupons” option 125 from a merchant web page such as, for example, a product placement web page 120 (FIG. 12). Package coupons help a merchant to increase sales by offering builders incentives for purchasing products from that merchant. A package coupon may have one or more conditions or requirements such as, for example, a quantity requirement, a total expenditure requirement, a time period restriction, and a user restriction. A merchant can create a package coupon by entering a coupon amount in the coupon value field 131, by entering and/or selecting coupon options and/or conditions in the coupon information section 132, and by then selecting the create coupon option 133. Once a package coupon is created, it is made available to builders and/or consumers via one or more RCPM web pages.

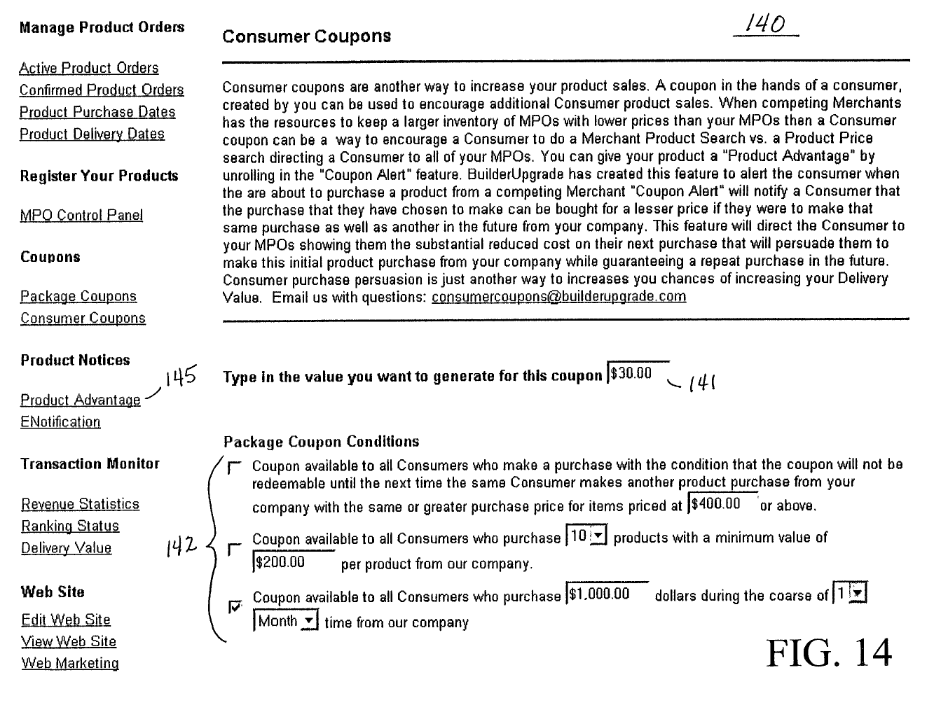

FIG. 14 illustrates a non-limiting example of a Consumer Coupons web page 140 that is presented to a merchant that selects the “consumer coupons” option 135 from a merchant web page such as, for example, the package coupons web page 130 (FIG. 13). Consumer coupons help a merchant to increase sales by offering consumers incentives for purchasing products from that merchant. A merchant can create a consumer coupon by entering a coupon amount in the coupon value field 141, by entering and/or selecting coupon options and/or conditions in the coupon information section 142, and by then selecting a create coupon option (not shown). Once a consumer coupon is created, it is made available to consumers via one or more RCPM web pages.

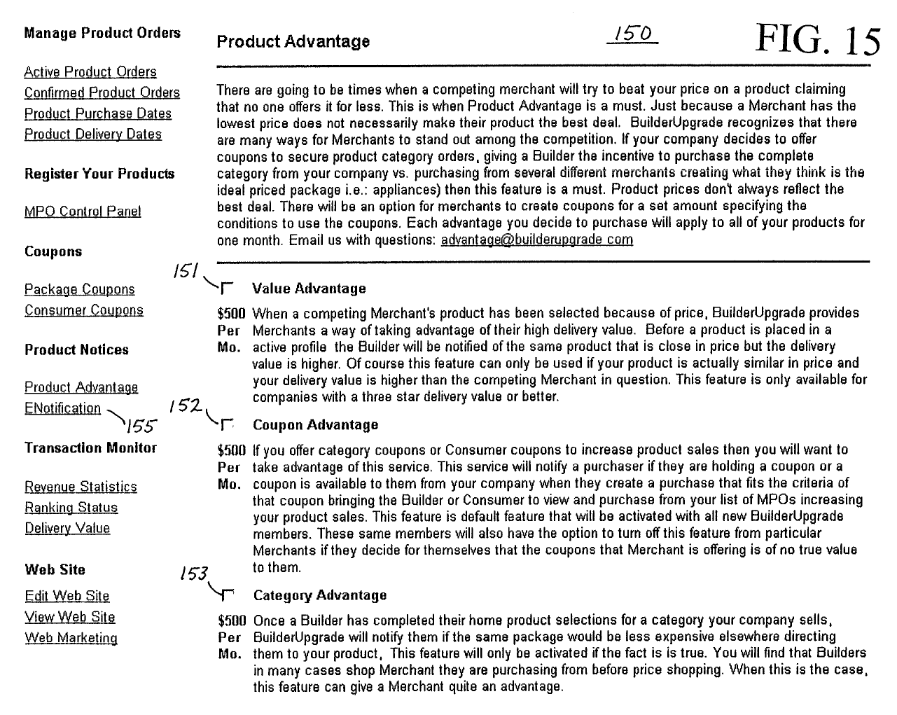

FIG. 15 illustrates a non-limiting example of a Product Advantage web page 150 that is presented to a merchant that selects the “product advantage” option 145 from a merchant web page such as, for example, the consumer coupons web page 140 (FIG. 14). The Product Advantage web page 150 offers merchants with the option of purchasing RCPM services that can provide the merchant with a competitive advantage. A merchant can purchase a Value Advantage service (VAS), a Coupon Advantage service (COAS), and/or a Category Advantage service (CAAS) by selecting the respective options 151, 152, and 153, and by then selecting a purchase button (not shown).

VAS provides a merchant with a way of taking advantage of the merchant's high delivery value by notifying builders that the merchant using VAS has a higher delivery value than a competing merchant from whom the builder is about to purchase a product. This notification is only provided if the merchant using VAS offers the same product at a comparable price and if such merchant does in fact have a higher delivery value. COAS is a service whereby a builder or purchaser is notified of the availability of a coupon from a merchant subscribing to COAS if the builder or purchaser selects one or more products for which the coupon is valid. CAAS is a service whereby a builder that selects a package of products is notified that a merchant subscribing to CAAS offers the package at a lower price than the merchant that is initially selected by the builder.

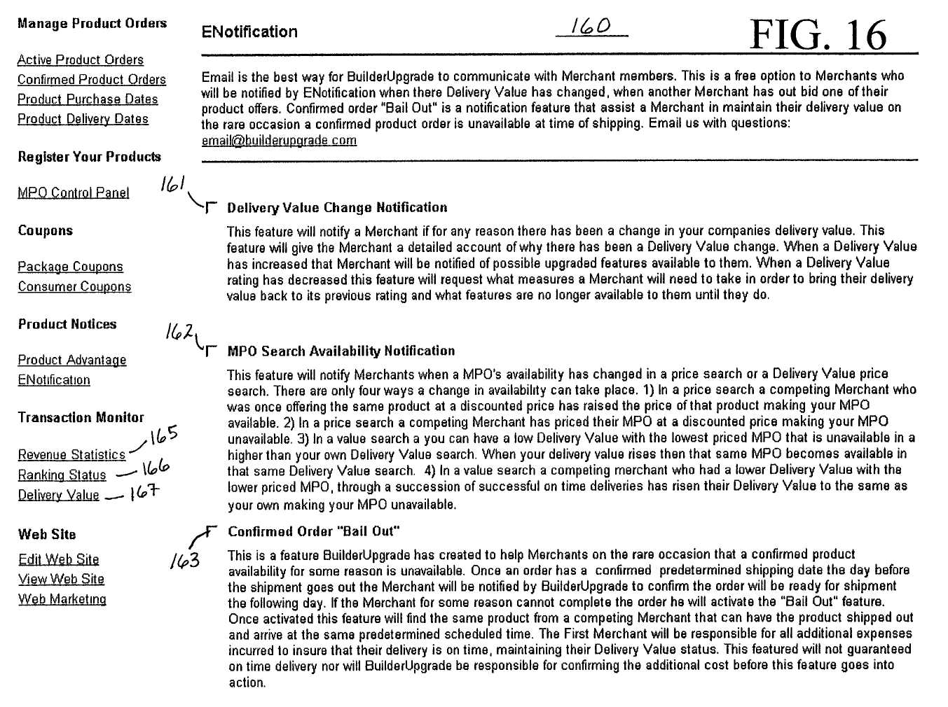

FIG. 16 illustrates a non-limiting example of an “ENotification” web page 160 that is presented to a merchant that selects the “product advantage” option 155 from a merchant web page such as, for example, the Product Advantage web page 150 (FIG. 15). The ENotification web page 160 offers a merchant the option of receiving free RCPM services that can provide the merchant with a competitive advantage. A merchant can request to receive a Delivery Value Change Notification service, an MPO Search Availability Notification service, and/or a Confirmed Order “Bail Out” service by selecting the respective options 161, 162, and 163, and by then selecting a subscribe button (not shown).

The Delivery Value Change Notification service provides a merchant with a notice when a there is a change in the merchant's delivery value informing the merchant of such change. The MPO Search Availability Notification service provides a merchant with a notice when a merchant's product is no longer included in a search result due to a change in the relative advantage that the merchant had in terms of product price or delivery value. The Confirmed Order “Bail Out” is a service whereby RCPM will “bail out” a merchant that is unable to fulfill a confirmed product order by arranging for another merchant to provide the confirmed product.

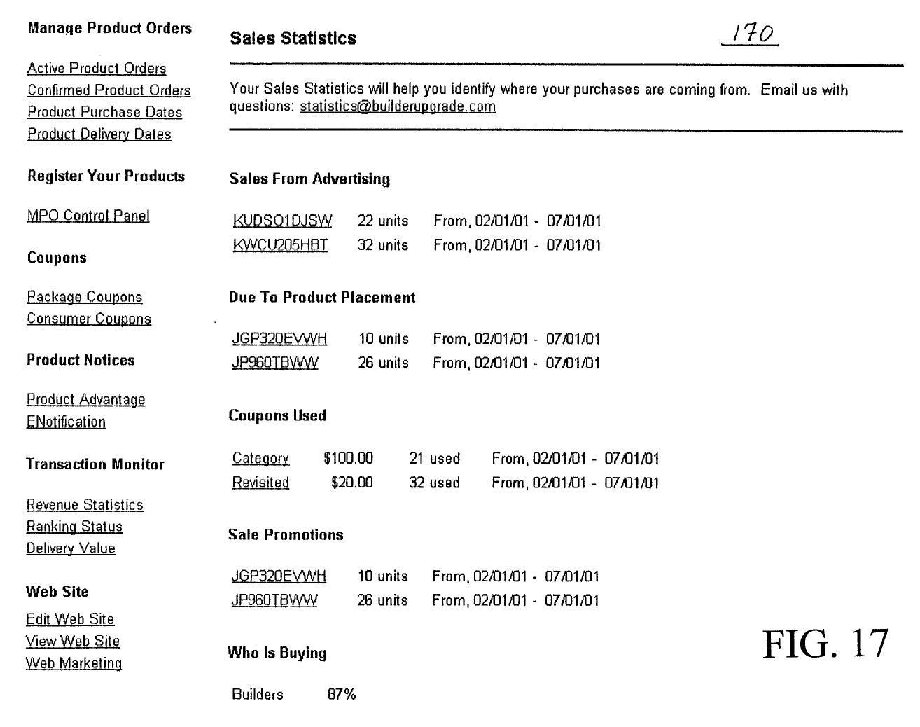

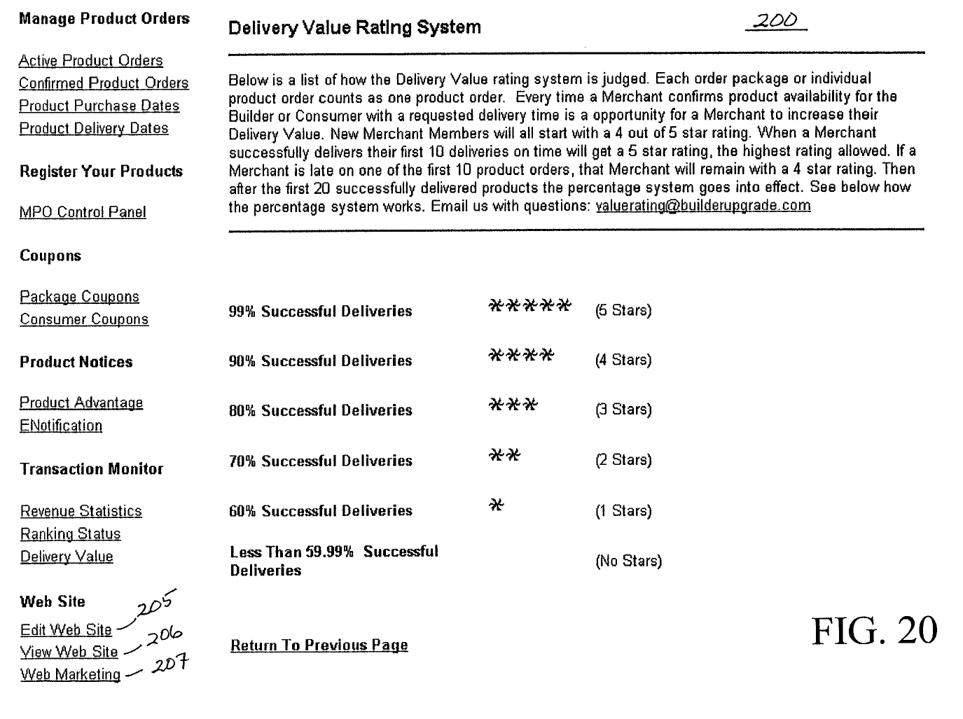

FIG. 17, 18, and 19 illustrate non-limiting examples of a Sales Statistics web page 170, a Ranking Status web page 180, and a Delivery Value web page 190, respectively, that can be requested by a merchant by selecting the corresponding hyperlinks 165, 166, and 167, respectively, from a merchant web page such as, for example, the ENotification web page 160 (FIG. 16); the Sales Statistics web 170 page provides the merchant with sales statistics related to the merchant's products; the Ranking Status web page 180 provides the merchant with merchant rankings that are based on percentages of sales volume achieved by the merchants via RCPM; and the Delivery Value web page 190 provides the merchant with the merchant's delivery value along with related information such as, for example, numbers for total deliveries and late deliveries achieved by the merchant for orders placed via RCPM. The Delivery Value web page 190 also provides access to a Delivery Value Rating System web page 200 (FIG. 20) via a delivery rating system hyperlink 195. The Delivery Value Rating System web page 200 provides information on the standards that are used to derive delivery value ratings.

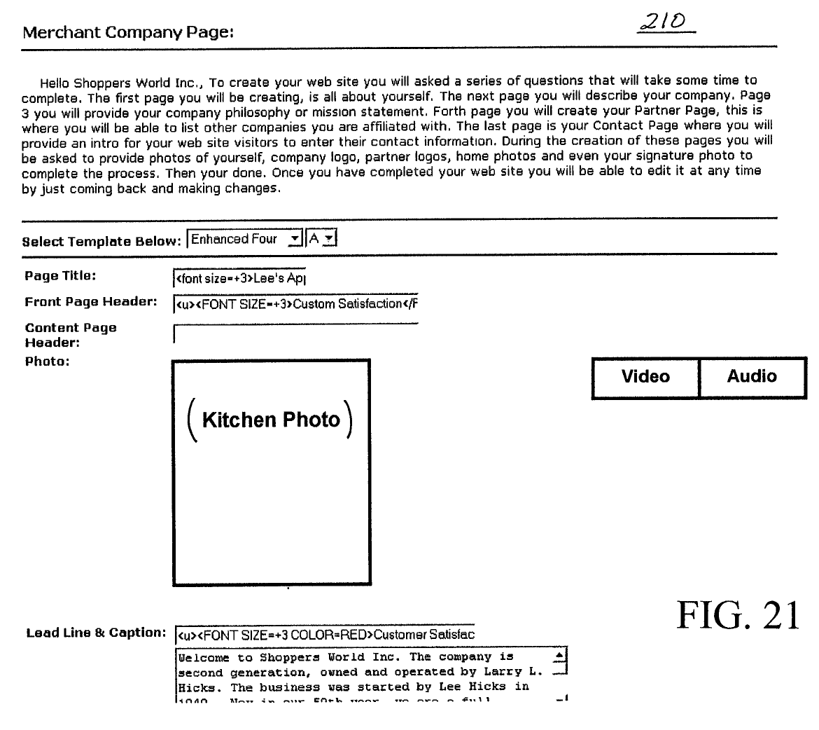

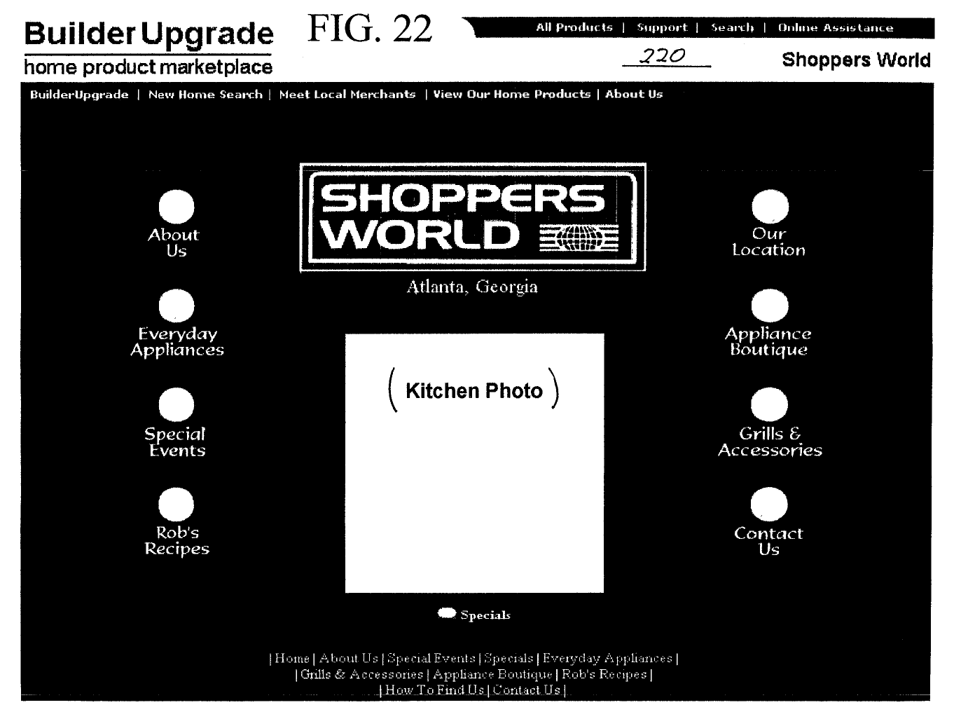

FIG. 21 illustrates a non-limiting example of a Merchant Company Page 210 that is presented to a merchant that selects the “edit web site” option 205 from a merchant web page such as, for example, the Delivery Value Rating System web page 200 (FIG. 20). The Merchant Company Page 210 provides a merchant with a template for creating a promotional web page (such as the one illustrated in FIG. 22) that promotes the merchant and that is hosted by RCPM on behalf of the merchant. FIG. 22 illustrates a non-limiting example of a promotional web page 220 that is created by a merchant using the Merchant Company Page 210. Promotional web page 220 can be requested by the merchant using the view web site option 206 via a merchant web page such as, for example, the Delivery Value Rating System web page 200 (FIG. 20). Promotional web page 220 (FIG. 22) contains hyperlinks that can be used to access additional information about the merchant and/or the merchant's product offerings. Builders, purchasers, and consumers, among others, would be provided access to the promotional web page 220 via the internet.

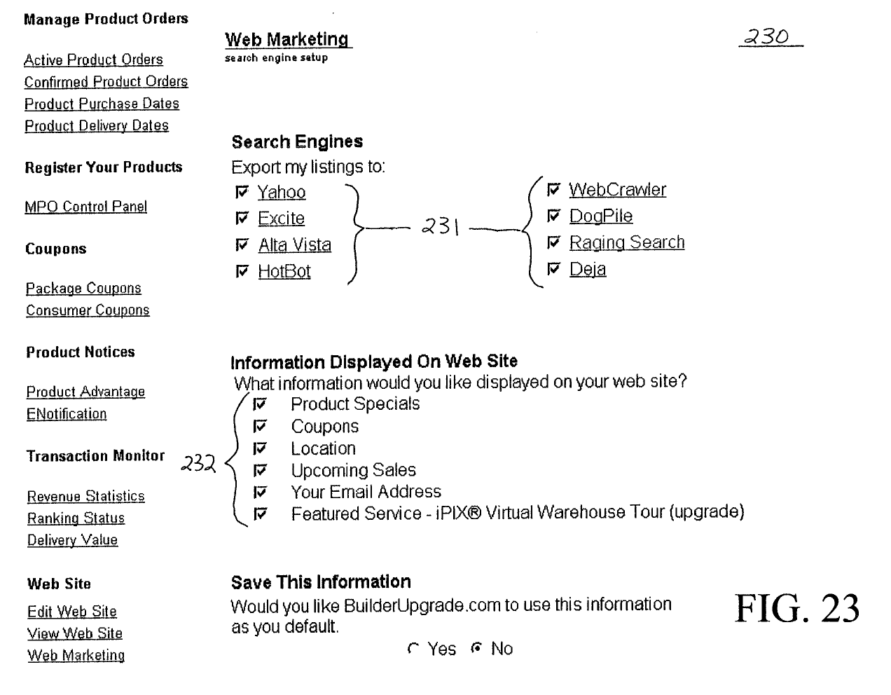

FIG. 23 illustrates a non-limiting example of a Web Marketing web page 230 that is presented to a merchant that selects the “web marketing” option 207 from a merchant web page such as, for example, the Delivery Value Rating System web page 200 (FIG. 20). The merchant can use options 231 to select search engines to which the merchant would like to export a listing of the merchant's promotional web page, and options 232 to select information that the merchant would like to make available via the merchant's promotional web page.

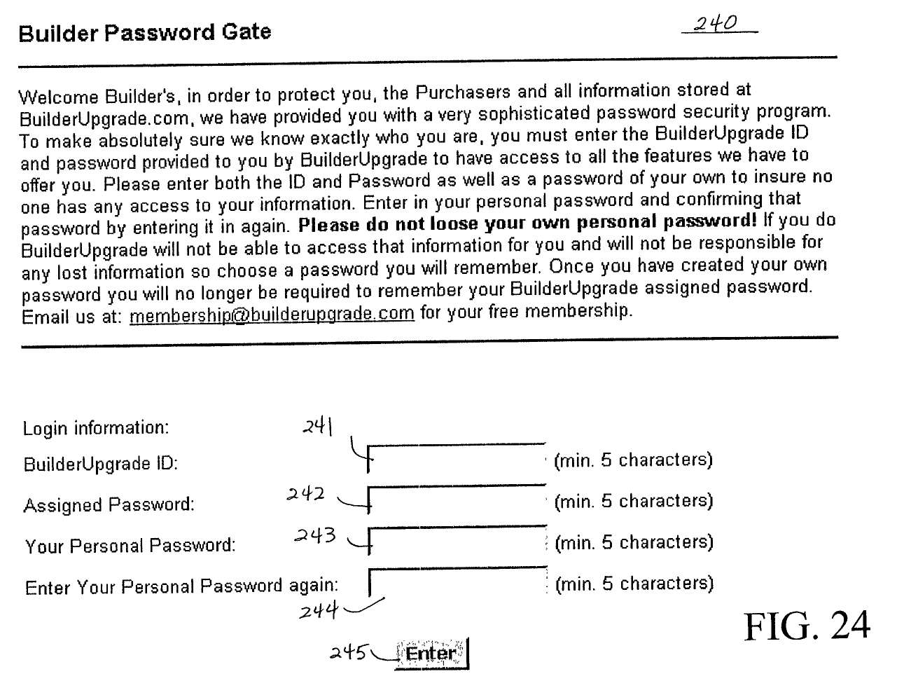

FIG. 24 illustrates a non-limiting example of a Builder Login web page 240 that is presented to a builder that selects the “Builder” option 46 (FIG.4) while being presented with an RCPM web page, such as, for example, home page 40. A builder that had previously registered with the RCPM system 11 can login by entering the builder's assigned RCPM ID, a corresponding assigned password, and a personal password in the fields 241, 242, and 243, respectively. Then, after re-entering the personal password in field 244, a builder can complete the login process by selecting the “enter” option 245.

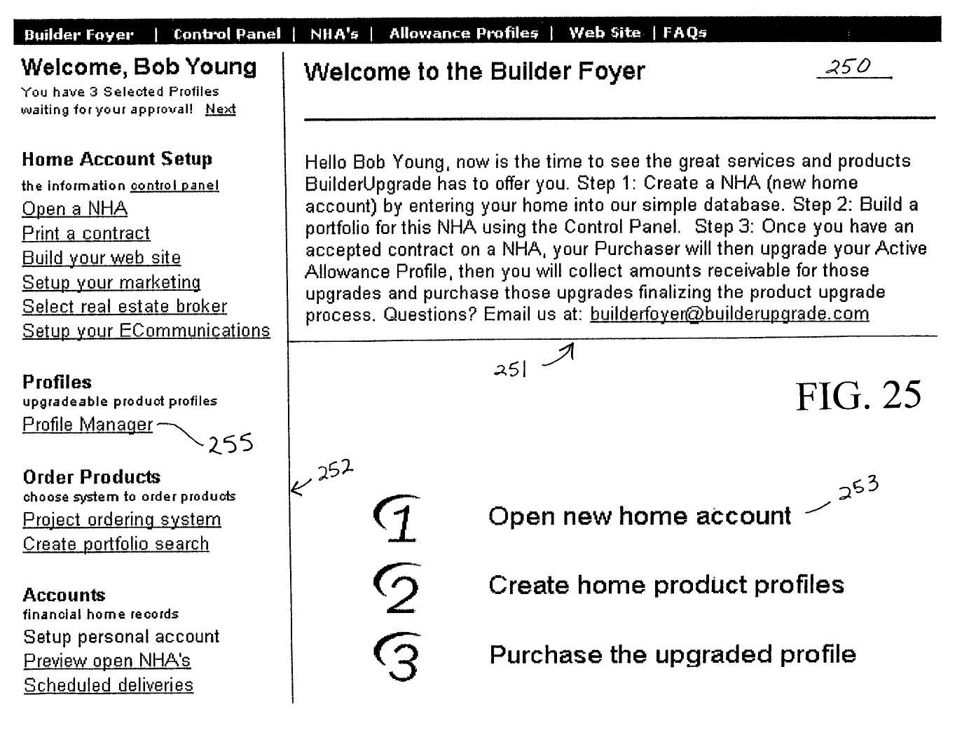

FIG. 25 illustrates a non-limiting example of a Builder Services web page 250 that is presented to a builder that logs into the RCPM system 11 using a valid RCPM ID and password combination. The builder information section 251 contains instructions about using the RCPM system 11. The left hand portion 252 of the web page contains hyperlinks to other web pages containing information and tools relevant to the builder. A builder can select the “open new home account” option 253 to begin the process of establishing a new home account (NHA).

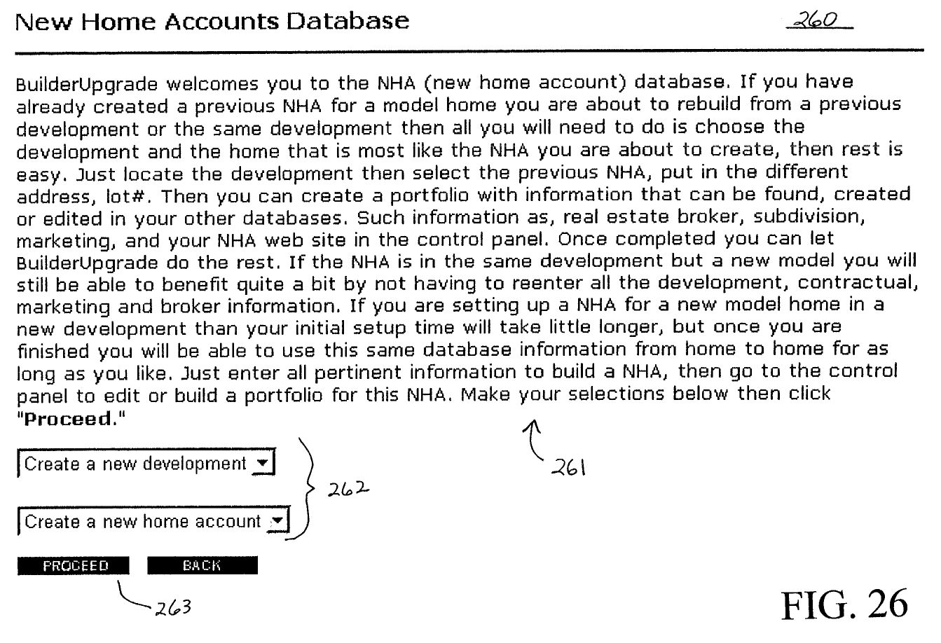

FIG. 26 illustrates a non-limiting example of a New Home Accounts Database web page 260 that is presented to a builder that selects the “open new home account” option 253 while being presented with the Builder Services web page 250 (FIG. 25). The New Home Accounts Database web page 260 contains instructions 261 on creating an NHA with RCPM. A builder can continue the process of establishing an NHA by selecting an appropriate option from the NHA options area 262 and by then selecting the “proceed” option 263. The NHA options area 262 can be used to specify whether the NHA corresponds to a new development and/or a new home.

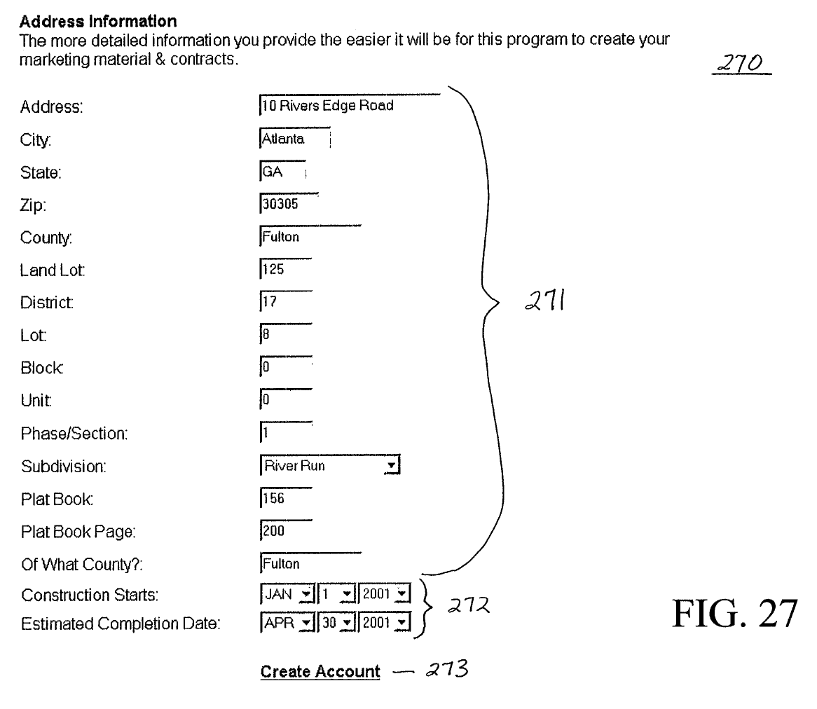

FIG. 27 illustrates a non-limiting example of an Address Information web page 270 that is presented to a builder that selects the “proceed” option 263 while being presented with the New Home Accounts Database web page 260 (FIG. 26). The Address Information web page 260 contains location entry fields 271 and date entry fields 272 that can be used by the builder to enter respective information about the location of, and construction time period for the new home for which an NHA is being established. Information entered by the builder may include, for example, a street address, a city, a state, a zip code, a county, a land lot, a district, a lot number, a block number, a unit number, a phase number, a subdivision name, a plat book number, a plat book page number, a construction start date, and an estimated construction completion date. Once a builder has finished entering the information, he can create a NHA for the new home by selecting the “Create Account” option 273.

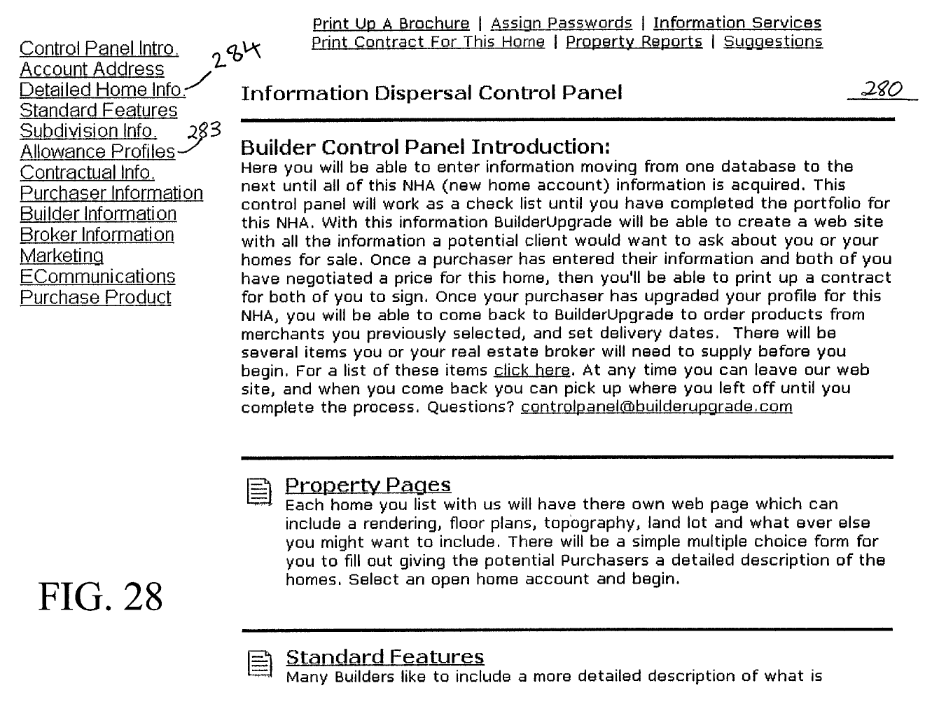

FIG. 28 illustrates a non-limiting example of an Information Dispersal Control Panel web page 280 that is presented to a builder that selects the “Create Account” option 273 while being presented with the an Address Information web page 270 (FIG. 27). The Information Dispersal Control Panel web page 280 contains information and instructions regarding services that RCPM offers to builders as well as hyperlinks to web pages that can be used to access and/or request RCPM services.

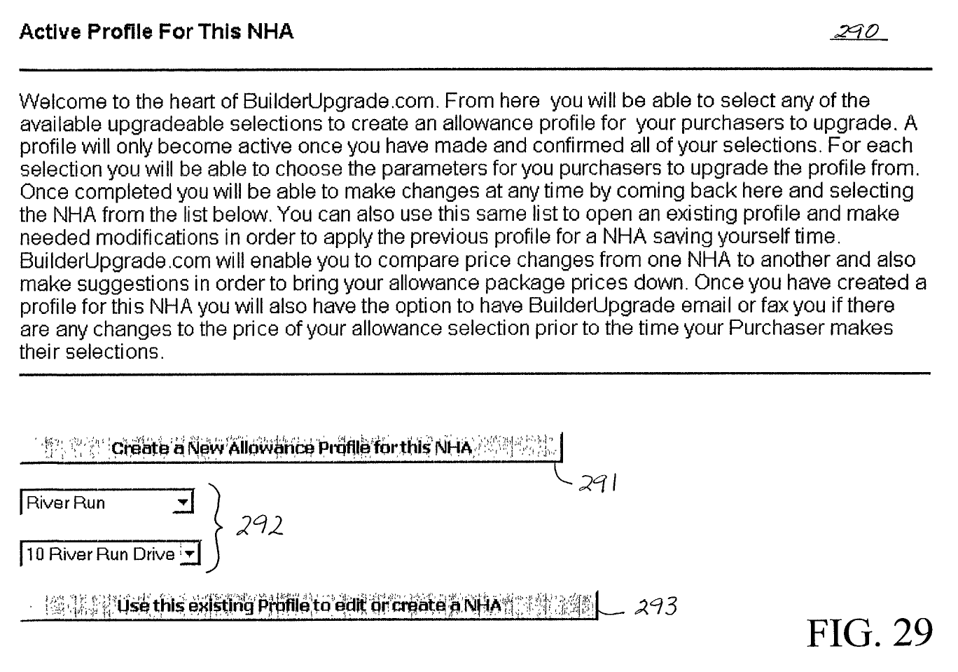

FIG. 29 illustrates a non-limiting example of a Profile Selection web page 290 that is presented to a builder that selects the “Allowance Profiles” option 283 while being presented with the Information Dispersal Control Panel web page 280 (FIG. 28). A builder can choose to create a new allowance profile by selecting option 291, or the builder can choose an existing profile as a starting point for creating an allowance profile for the NHA. If a builder elects to use the latter approach, the builder can do so by specifying, via selection fields 292, the address of the property for which the existing profile belongs, and by then selecting the “use this existing profile . . . ” option 293.

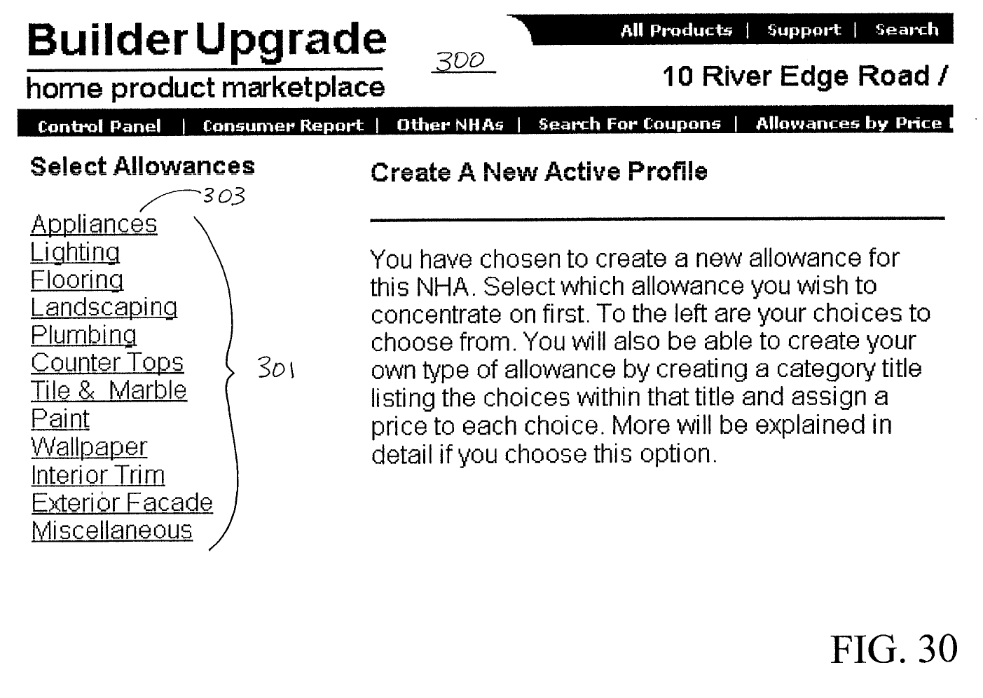

FIG. 30 illustrates a non-limiting example of a New Active Profile web page 300 that is presented to a builder that selects option 291 while being presented with the Profile Selection web page 290 (FIG. 29). The New Active Profile web page 300 contains construction item category hyperlinks 301 that provide access to web pages containing information and/or selections pertaining to the respective categories. Construction item categories include, in this example, appliances, lighting, flooring, landscaping, plumbing, counter tops, tile & marble, paint, wallpaper, interior trim, and exterior facade.

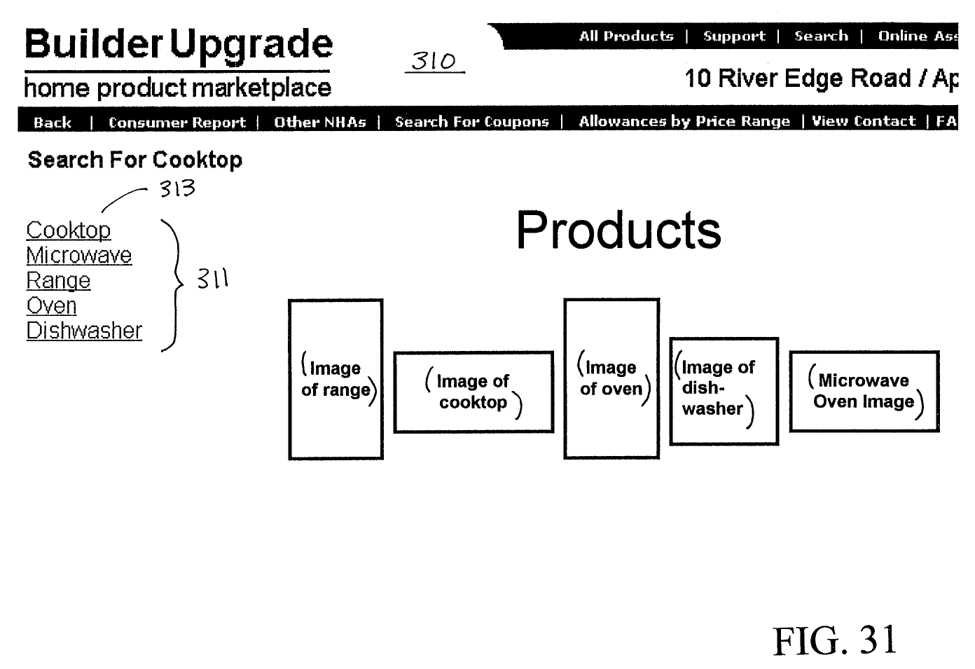

FIG. 31 illustrates a non-limiting example of an Appliance Selection web page 310 that is presented to a builder that selects the “Appliances” option 303 while being presented with the New Active Profile web page 300 (FIG. 30). The Appliance Selection web page 310 contains appliance type hyperlinks 311 that provide access to web pages containing information and/or selections pertaining to the respective appliance types. Types of appliances include, in this example, cooktops, microwave ovens, cooking ranges, ovens, and dishwashers.

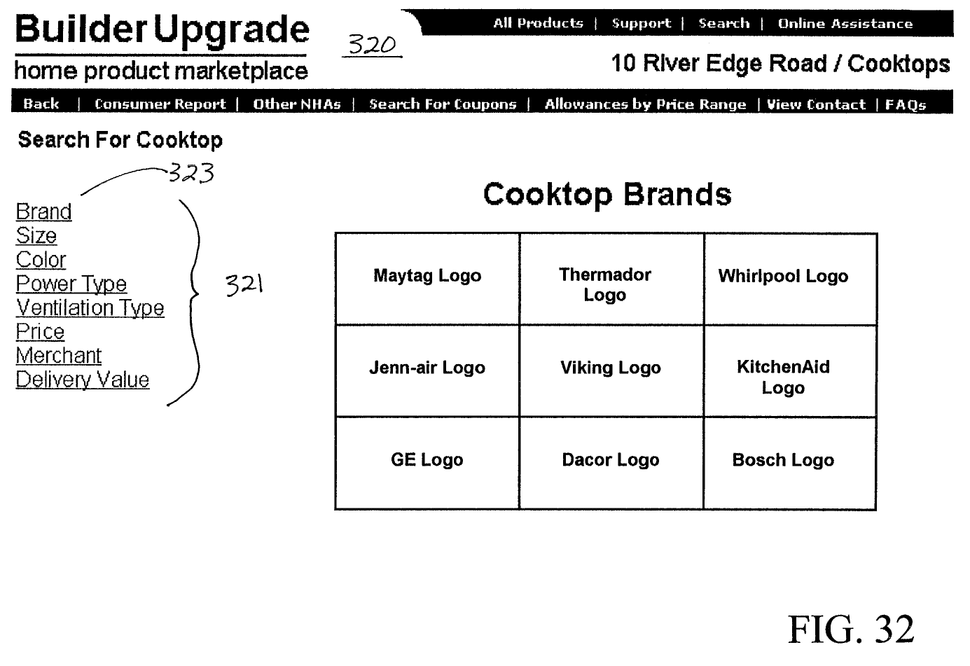

FIG. 32 illustrates a non-limiting example of a Cooktop Search web page 320 that is presented to a builder that selects the “Cooktop” option 313 while being presented with the Appliance Selection web page 310 (FIG. 31). The Cooktop Search web page 320 contains cooktop search criteria hyperlinks 321 that provide access to web pages containing cooktop selections that are sorted based on the respective cooktop search criteria. Cooktop search criteria include, in this example, brand name, size, color, power type (e.g. gas or electricity), ventilation type, price, merchant, and delivery value.

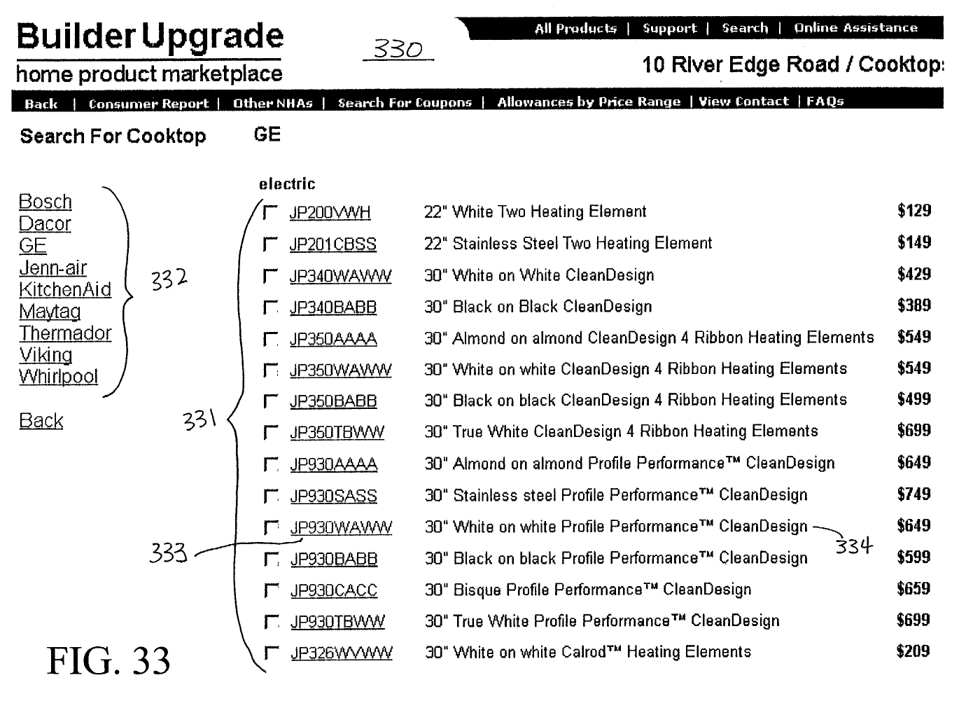

FIG. 33 illustrates a non-limiting example of a Cooktop Listing web page 330 that is presented to a builder that selects the “Brand” option 323 while being presented with the Cooktop Search web page 320 (FIG. 32). The Cooktop Listing web page 320 contains a list of cooktops 331 as well as brand name hyperlinks 332 that can provide access to web pages containing cooktop selections that are sorted based on the respective cooktop name brands. Cooktop brand names include, in this example, Bosch, Dacor, GE, Jenn-air, KitchenAid, Maytag, Thermador, Viking, and Whirlpool.

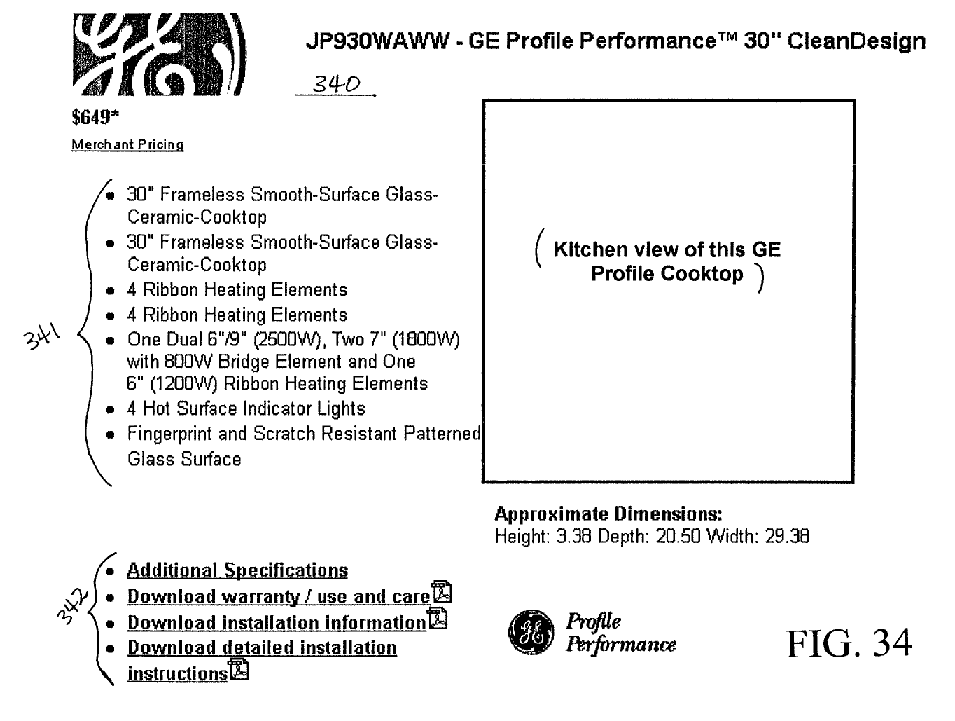

FIG. 34 illustrates a non-limiting example of a Cooktop Information web page 340 that is presented to a builder that selects the “JP930WAWW” cooktop hyperlink 333 while being presented with the Cooktop Listing web page 330 (FIG. 33). The Cooktop Information web page 340 contains cooktop information 341 about the selected cooktop 334 (FIG. 33) as well as cooktop hyperlinks 342 that can provide access to additional information related to the selected cooktop 334.

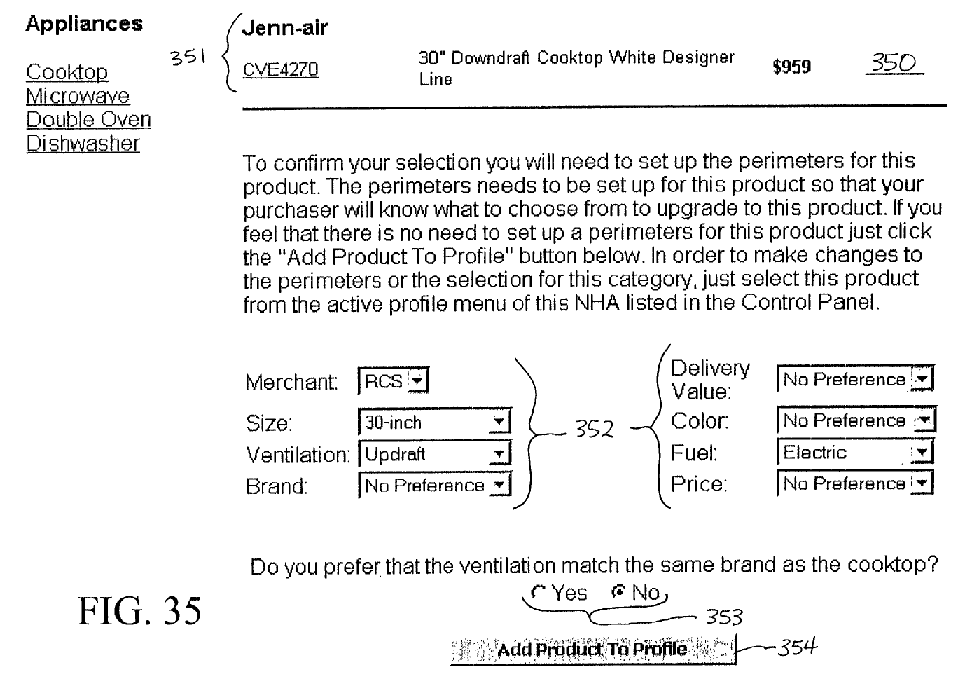

FIG. 35 illustrates a non-limiting example of a Selection Confirmation web page 350 that is presented to a builder that places an order for an item via an item selection web page. The top portion 351 contains information about the selected item including, for example, a brand name, a reference number, a product description, and a product price. The builder may also place restrictions on how a home purchaser can upgrade the selected item by selecting restrictions from the restriction selection list 352. In addition, the builder may indicate a preference via options 353 as to whether a related item should have the same brand name. Once a builder is ready to add the item to a product profile, the builder can select the “Add Product To Profile” option 354.

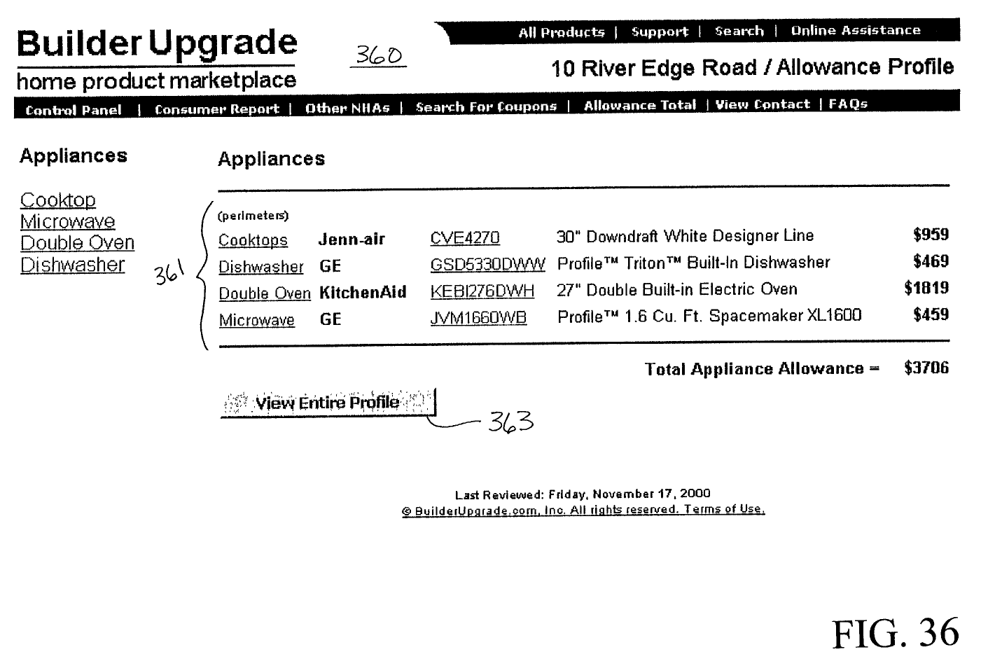

FIG. 36 illustrates a non-limiting example of an Appliance Profile web page 360 that is presented to a builder that selects the “Add Product To Profile” option 354 while being presented with the Selection Confirmation web page 350 (FIG. 35). The Appliance Profile web page 360 contains a list of appliances 361 that have been selected by the builder for the NHA. A builder may choose to view an entire profile for the NHA by selecting the “View Entire Profile” option 363.

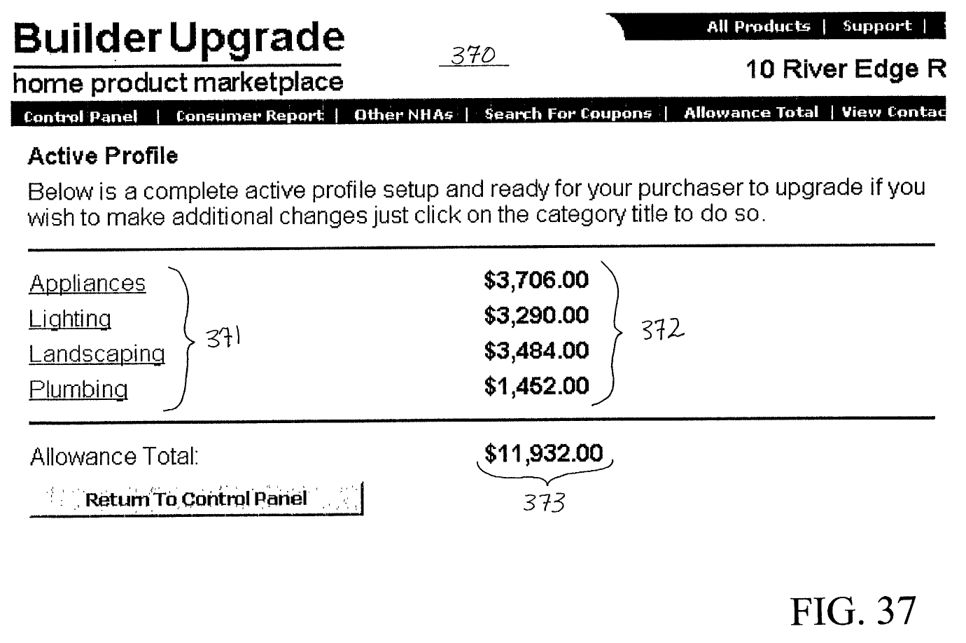

FIG. 37 illustrates a non-limiting example of an Active Profile web page 370 that is presented to a builder that selects the “View Entire Profile” option 363 while being presented with the Appliance Profile web page 360 (FIG. 36). The Active Profile web page 370 contains a list of categories 371 for which products have been selected as well as corresponding total prices 372 for the products in the respective categories. An allowance total 373 shows the total price of the selected products for the NHA.

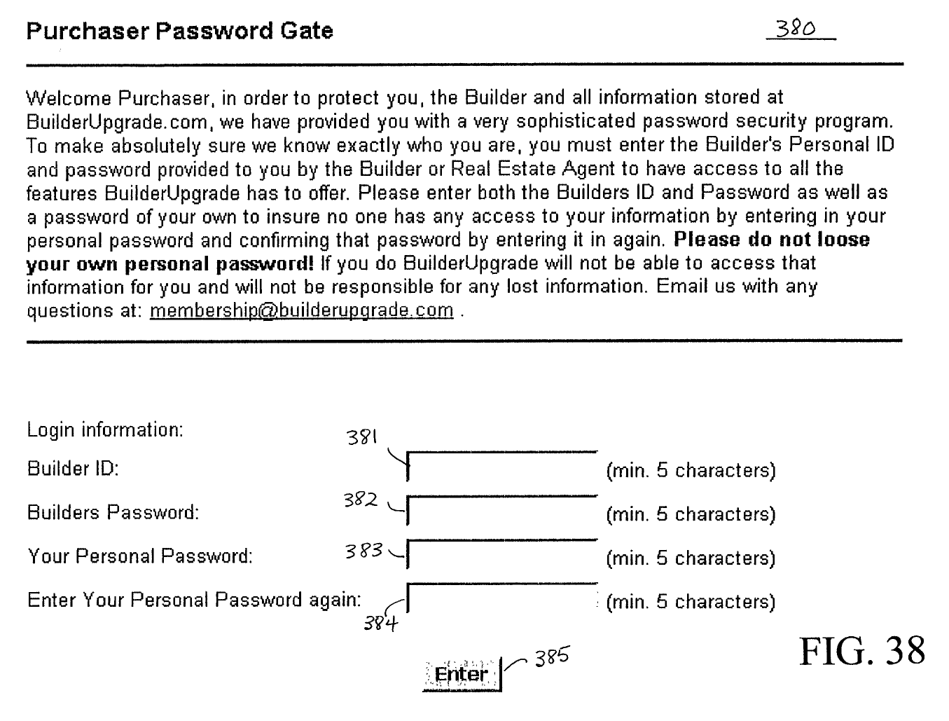

FIG. 38 illustrates a non-limiting example of a Home Purchaser Login web page 380 that is presented to a home purchaser that selects the “Home purchaser” option 47 while being presented with an RCPM web page, such as, for example, home page 40 (FIG.4). A home purchaser that had previously registered with the RCPM system 11 can login by entering an RCPM ID, a corresponding assigned password, and a personal password in the fields 381, 382, and 383 respectively. Then, after re-entering the personal password in field 384 a home purchaser can complete the login process by selecting the “enter” option 385.

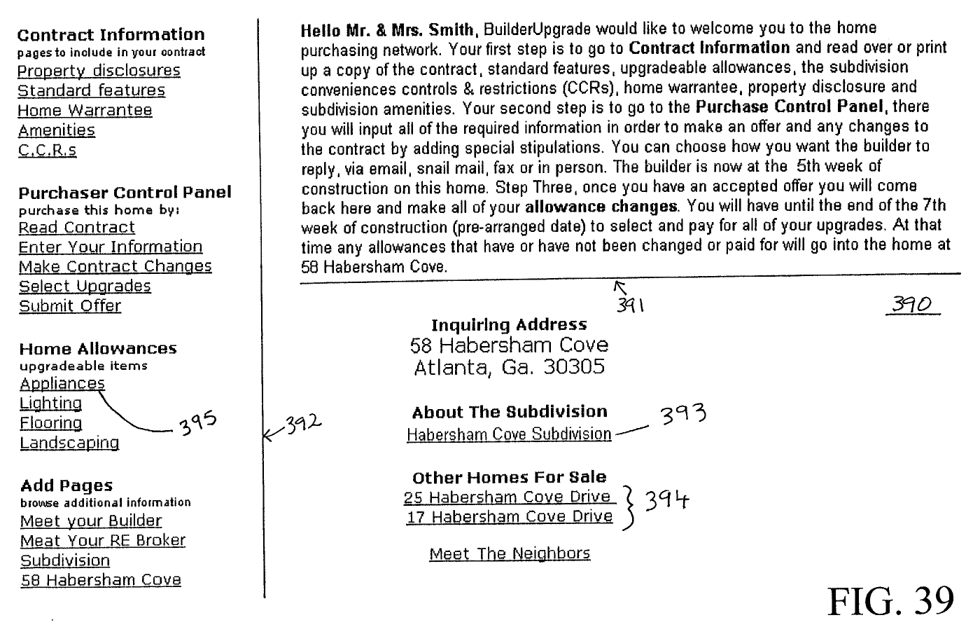

FIG. 39 illustrates a non-limiting example of a Home Purchaser Services web page 390 that is presented to a home purchaser that logs into the RCPM system 11 using a valid RCPM ID and password combination. The home purchaser information section 391 contains instructions about using the RCPM system 11. The left hand portion 392 of the web page contains hyperlinks to other web pages containing information and tools relevant to the home purchaser. Hyperlink 393 provides access to information about the subdivision in which the home purchaser's new home will be located, and hyperlinks 394 provides access to information about the other homes in the subdivision.

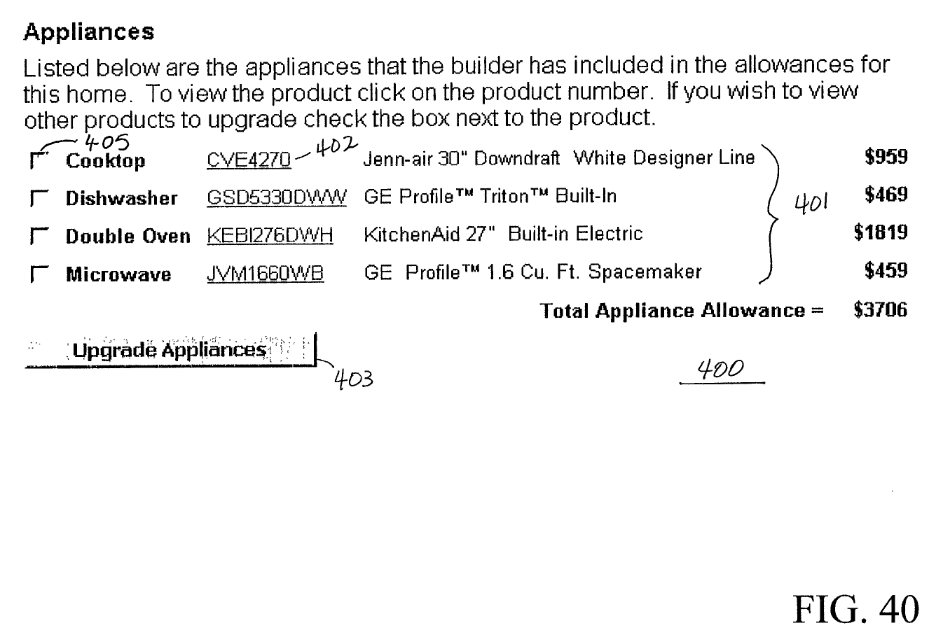

FIG. 40 illustrates a non-limiting example of an Appliance Selection web page 400 that is presented to a home purchaser that selects the “Appliances” option 395 while being presented with the Home Purchaser Services web page 390 (FIG.39). The Appliance Selection web page 400 contains a list of appliances 401, as well as hyperlinks, such as hyperlink 402, that provide access to web pages for upgrading corresponding appliance selections. A home purchaser can access an appliance upgrade web page by selecting a box located next to the appliance to be upgraded, and by then selecting the “Upgrade Appliances” option 403.

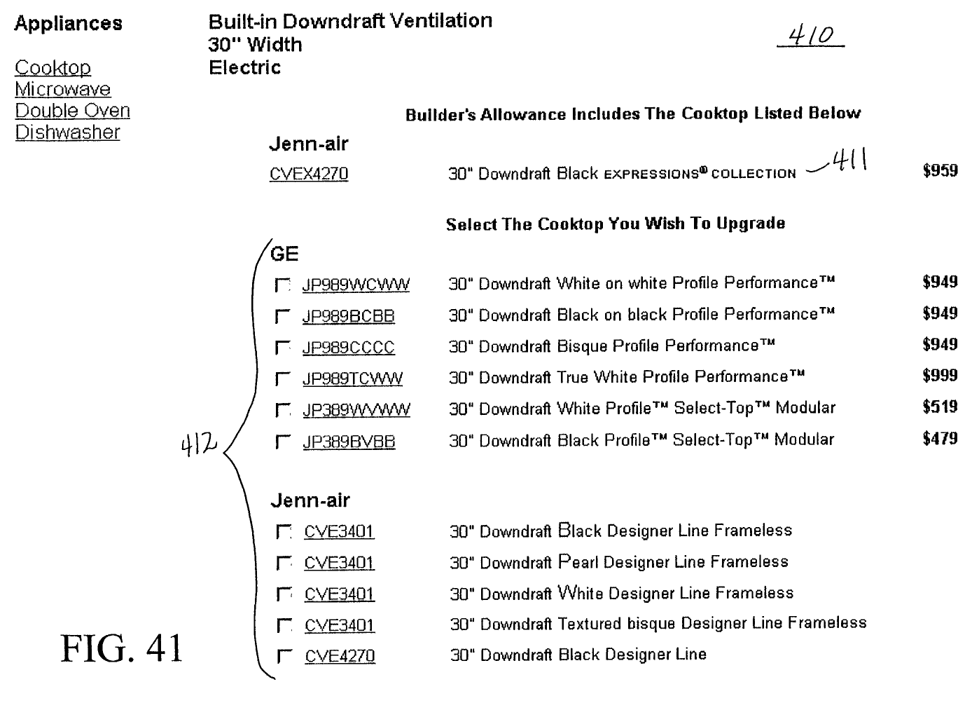

FIG. 41 illustrates a non-limiting example of a Cooktop Upgrade web page 410 that is presented to a home purchaser that selects the “Cooktop” option 405 while being presented with Appliance Selection web page 400 (FIG.40). The Cooktop Upgrade web page 410 provides a description of the currently selected cooktop 411 as well as a list of alternative cooktop selections 412.

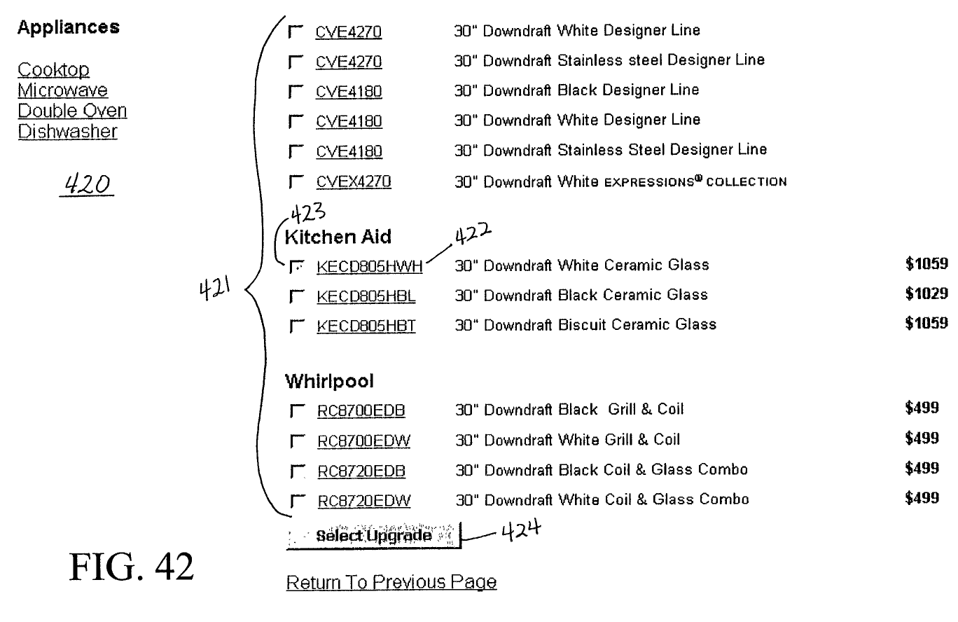

FIG. 42 illustrates a non-limiting example of a Cooktop Upgrade web page 420 scrolled down version of the Cooktop Upgrade web page 410. The Cooktop Upgrade web page 420 also includes a list of cooktop selections 421. A home purchaser can access a more detailed description of a cooktop identified in the list of cooktop selections 421 by selecting the hyperlink corresponding to such cooktop. Once a home purchaser has made a decision as to which cooktop the home purchaser desires instead of the currently selected cooktop, the home purchaser would select a box located next to the desired cooktop selection and would then select the “Upgrade” option 424.

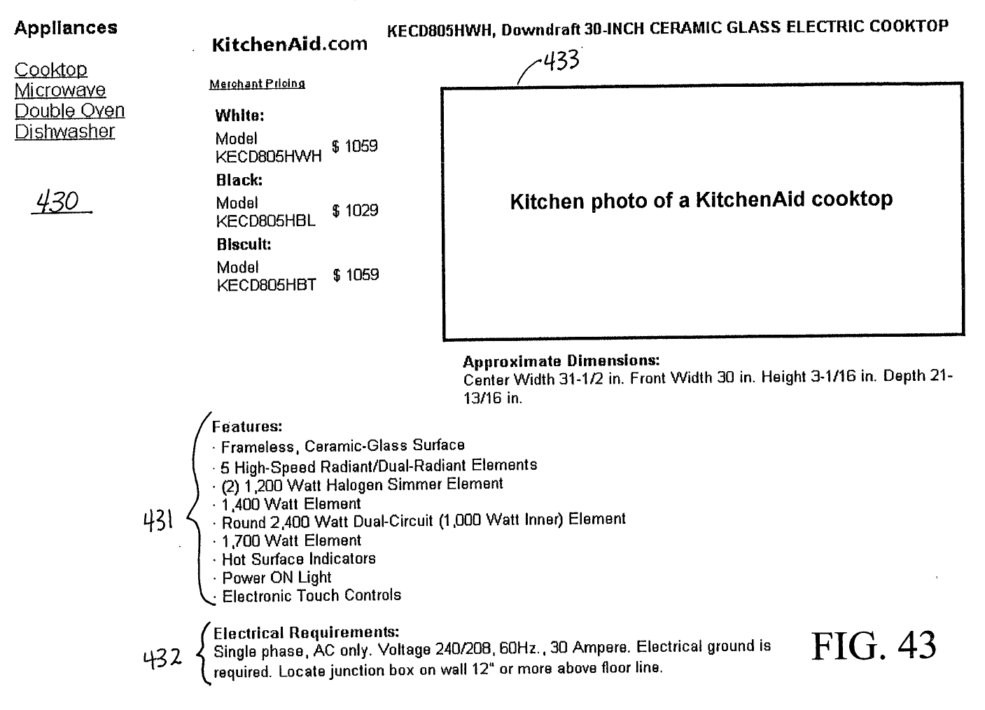

FIG. 43 illustrates a non-limiting example of a Cooktop Information web page 430 that is presented to a home purchaser that selects the cooktop hyperlink 422 while being presented with the Cooktop Upgrade web page 420 (FIG.42). The Cooktop Information web page 430 contains a list of cooktop features 431, a list of electrical requirements 432, and an image 433 for a cooktop corresponding to the selected hyperlink 422 (FIG.42).

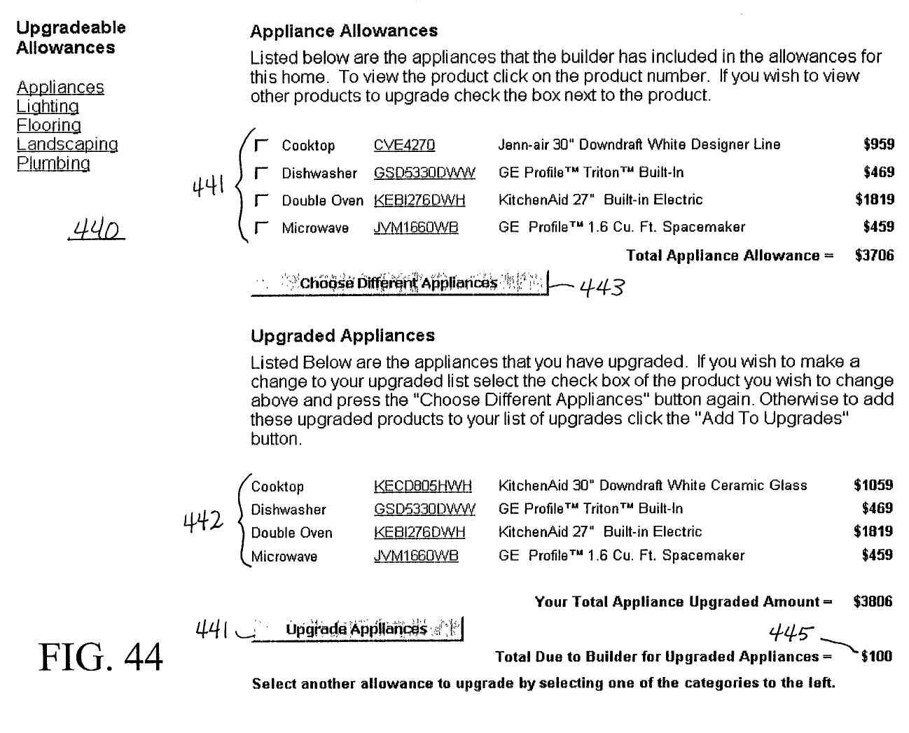

FIG. 44 illustrates a non-limiting example of an Upgrade Confirmation web page 440 that is presented to a home purchaser that selects the “Upgrade” option 424 while being presented with the Cooktop Upgrade web page 420 (FIG.42). The Upgrade Confirmation web page 440 contains a list of current product selections 442 that reflects the upgrade(s) that the home purchaser has made to one or more product selections listed in the list of original product selections 441. The home purchaser is also provided with cost information 445 informing the home purchaser the amount that the home purchaser owes the builder in connection with making alternative product selection(s). If the home purchaser decides to continue making product upgrades (alternative selections), then the home purchaser would select the “Choose Different Appliances” option 443, whereas if the home purchaser decides to confirm the current product selections 442, then the home purchaser would select the “Upgrade Appliances” option 441.

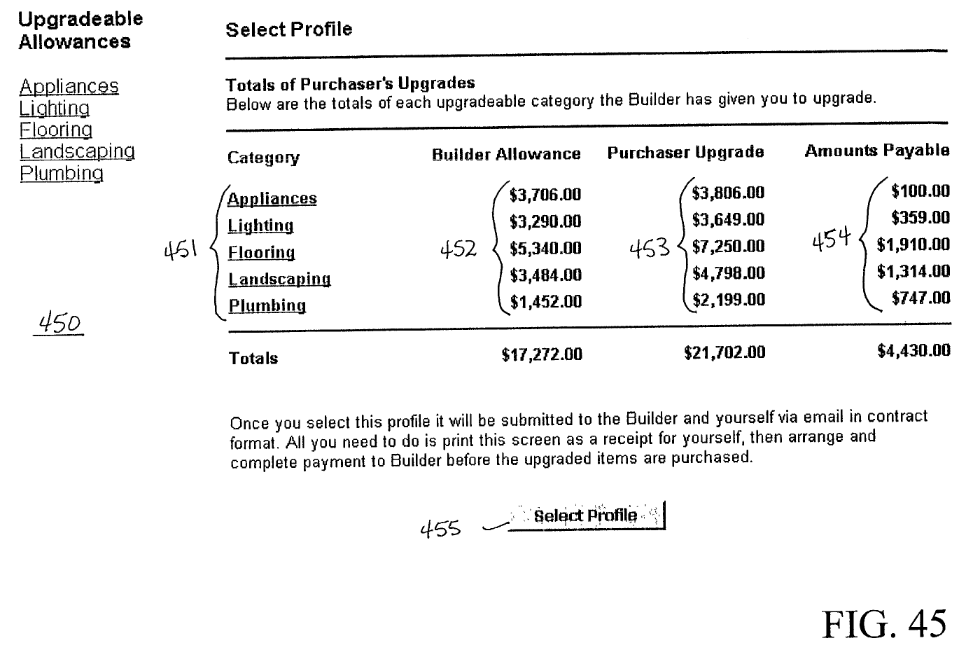

FIG. 45 illustrates a non-limiting example of a Profile Confirmation Web Page 450 that is presented to a home purchaser that selects the “Upgrade Appliances” option 441 while being presented with the Upgrade Confirmation web page 440 (FIG.44). The Profile Selection Web Page 450 contains a list of product categories 451, as well as corresponding lists for builder allowances 452, purchaser upgrades 453, and amounts payable 454. A home purchaser can confirm the current product profiles by selecting the “Select Profile” option 455.

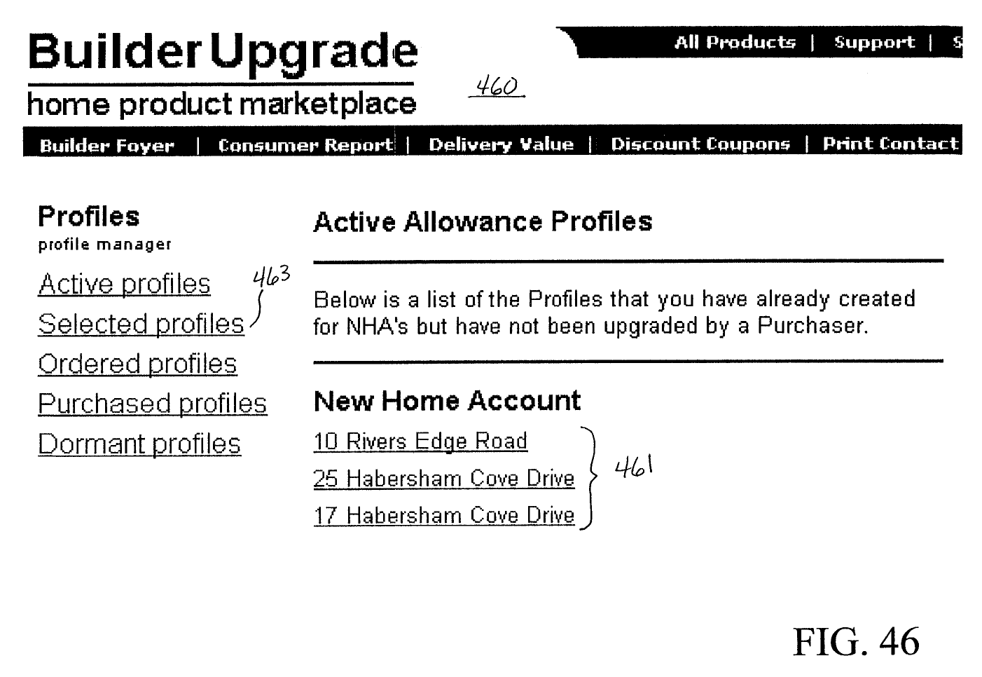

FIG. 46 illustrates a non-limiting example of a Profile Manager web page 460 that is presented to a builder that selects the “Profile Manager” option 255 while being presented with the Builder Services web page 250 (FIG. 25). The Profile Manager web page 460 contains a list of address hyperlinks 461 that can provide access to respective product profiles that have not yet been upgraded by respective home purchasers. A “Selected Profiles” hyperlink 463 provides access to product profiles that have been upgraded and/or confirmed by respective home purchasers.

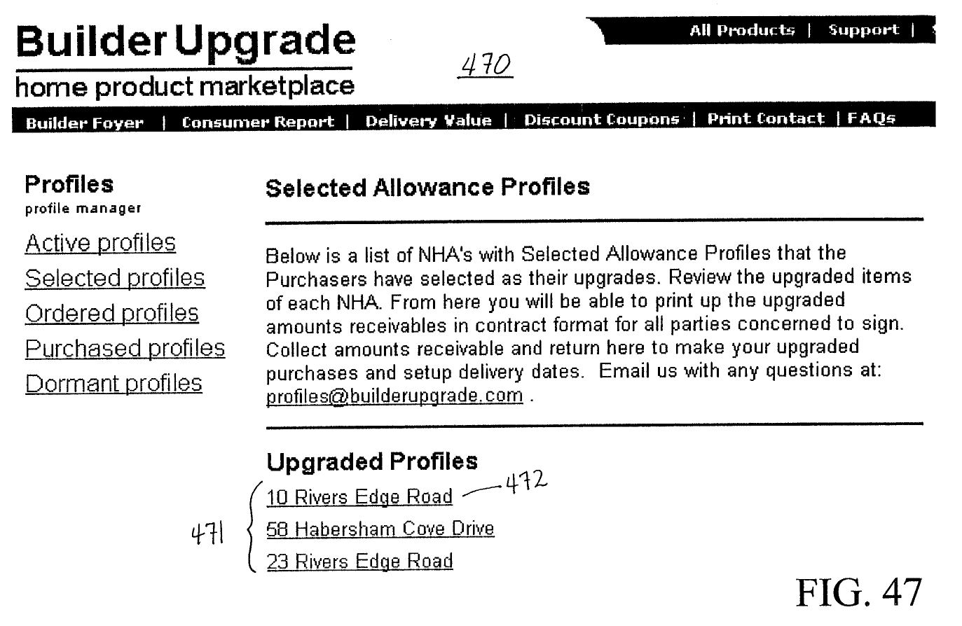

FIG. 47 illustrates a non-limiting example of a Selected Allowance Profiles web page 470 that is presented to a builder that selects the “Selected Profiles” hyperlink 463 while being presented with the Profile Manager web page 460 (FIG. 46). The Selected Allowance Profiles web page 470 contains a list of address hyperlinks 471 that can provide access to respective product profiles that have been upgraded and/or confirmed by respective home purchasers. As a non-limiting example, the “10 Rivers Edge Road” hyperlink 472 provides a link to a purchaser confirmed and/or modified product profile for a home that is being or will be constructed by the builder at the location “10 Rivers Edge Road”.

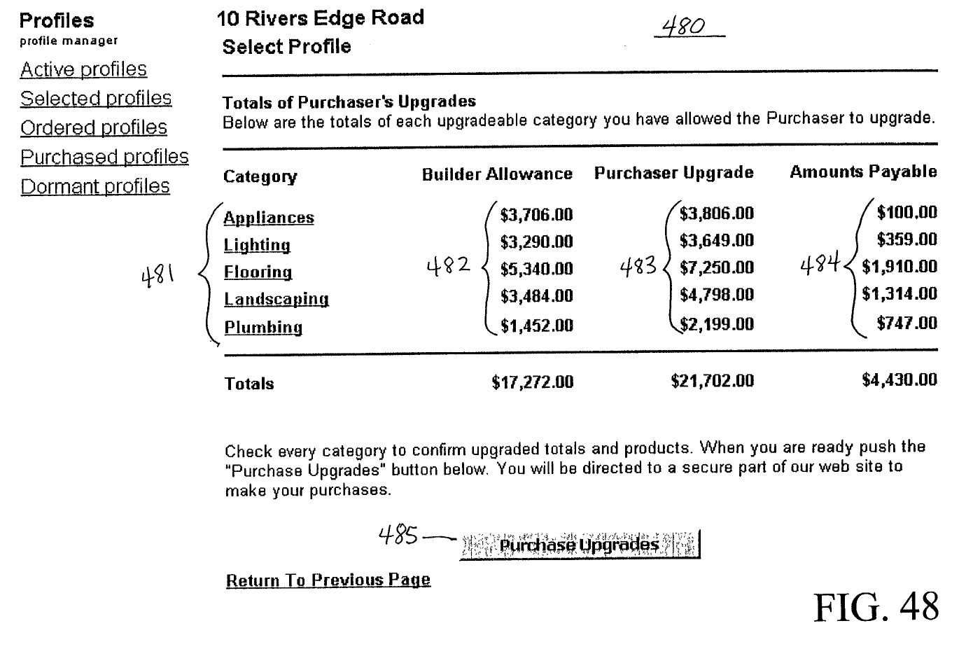

FIG. 48 illustrates a non-limiting example of a Selected Profile web page 480 that is presented to a builder that selects the “10 Rivers Edge Road” hyperlink 472 while being presented with the Selected Allowance Profiles web page 470 (FIG. 47). The Selected Profile web page 480 contains a list of product categories 481, as well as corresponding lists for builder allowances 482, purchaser selections' prices 483, and amounts payable 484. A builder can access a detailed product profile for a category by selecting a corresponding hyperlink. If a builder is satisfied with the current product profiles, the builder would then select the “Purchase Upgrades” option 485.

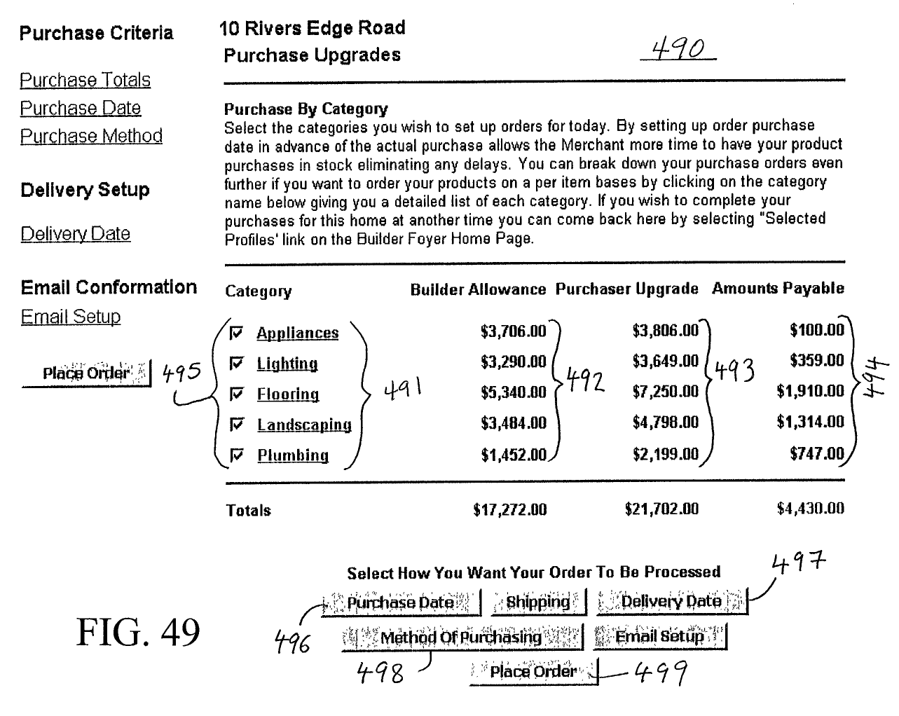

FIG. 49 illustrates a non-limiting example of a Purchase web page 490 that is presented to a builder that selects the “Purchase Upgrades” option 485 while being presented with the Selected Profile web page 480 (FIG. 48). The Purchase web page 490 contains a list of product categories 491, as well as corresponding lists for builder allowances 492, purchaser selections' prices 493, and amounts payable 494. A builder can select one or more boxes from the corresponding category boxes 495 and then select a Purchase Date option 496, a Delivery Date option 497, a Method of Purchasing option 498, or a Place Order option 499 in order to access a respective web page for setting a purchase date, setting a delivery date, selecting a method of purchasing, or placing an order.

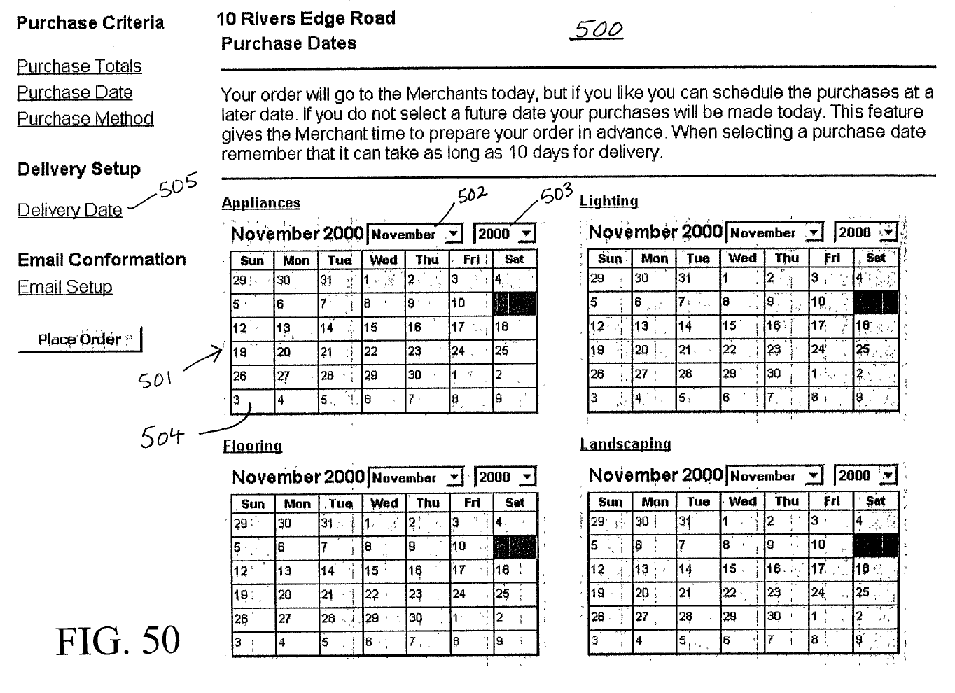

FIG. 50 illustrates a non-limiting example of a Purchase Dates web page 500 that is presented to a builder that selects the “Purchase Date” option 496 while being presented with the Purchase web page 490 (FIG. 49). An interactive calendar 501 is provided for each category of products, although, in this example, only four calendars are shown; a builder can scroll down to view an interactive calendar for plumbing products. Each interactive calendar has a month selection field 502 and a year selection field 503. After a builder selects a desired year and month for the purchase of the respective category of products, the builder can select a square 504 corresponding to a desired day for said purchase.

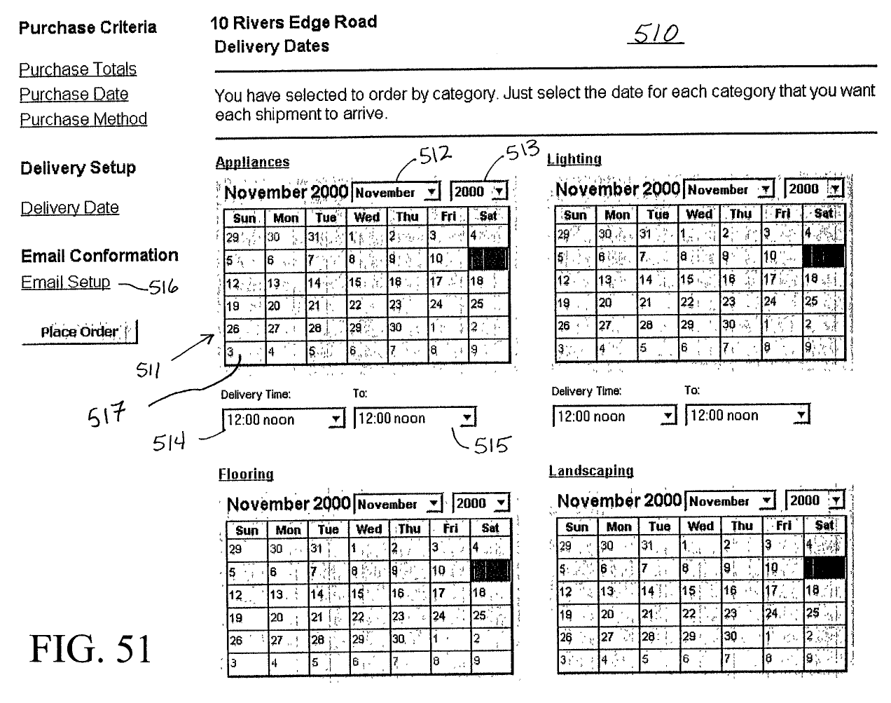

FIG. 51 illustrates a non-limiting example of a Delivery Dates web page 510 that is presented to a builder that selects the “Delivery Date” option 497 while being presented with the Purchase web page 490 (FIG. 49). An interactive calendar 511 is provided for each category of products, although, in this example, only four calendars are shown; a builder can scroll down to view an interactive calendar for plumbing products. Each interactive calendar has a month selection field 512 and a year selection field 513. After a builder selects a desired year and month for the purchase of the respective category of products, the builder can select a square 517 corresponding to a desired day for said purchase, as well as a delivery time span via time fields 514 and 515.

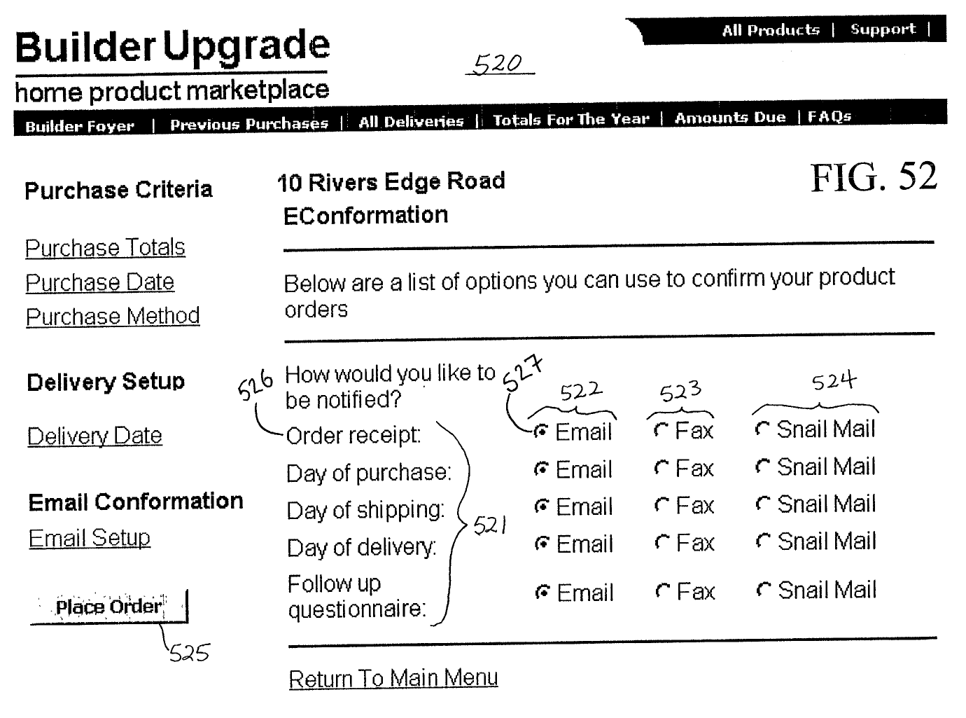

FIG. 52 illustrates a non-limiting example of an EConfirmation web page 520 that is presented to a builder that selects the “Email Setup” option 516 while being presented with the Delivery Dates web page 510 (FIG. 51). The EConfirmation web page 520 includes a list of notices 521 that the builder can expect to receive from the RCPM system 11. The builder can select a method of delivery for each listed notice 526 by selecting a corresponding circle 527 from a list of email selections 522, a list of fax selections 523, and a list of snail mail (post office mail) selections 524. A builder may also access a web page for placing an order by selecting the “Place Order” option 525.

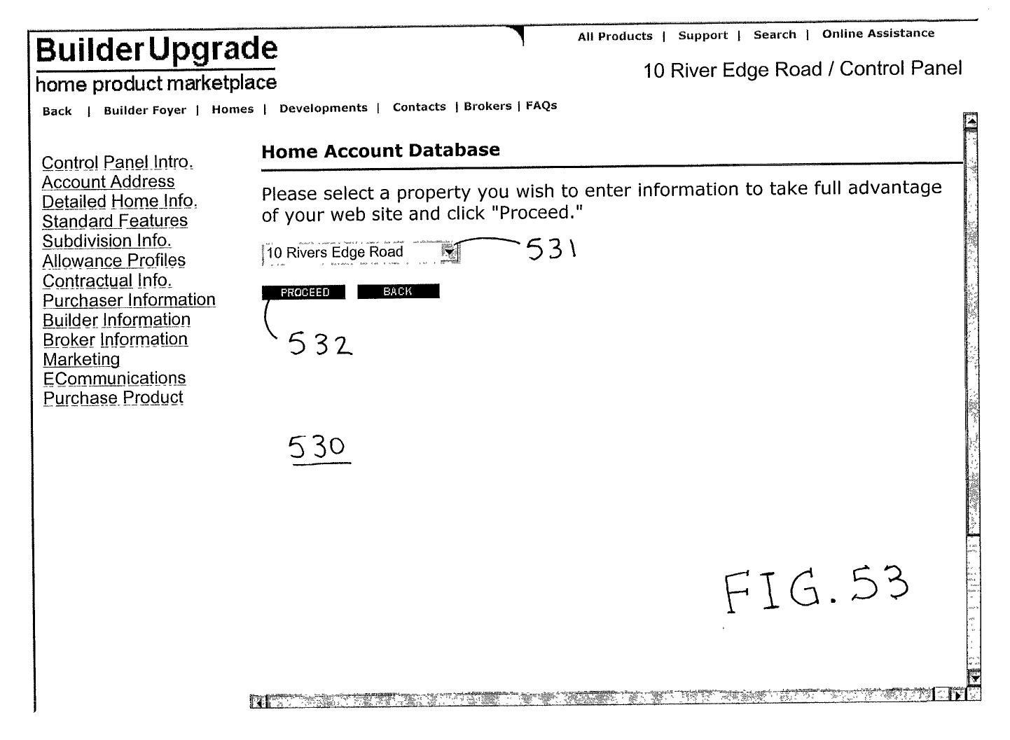

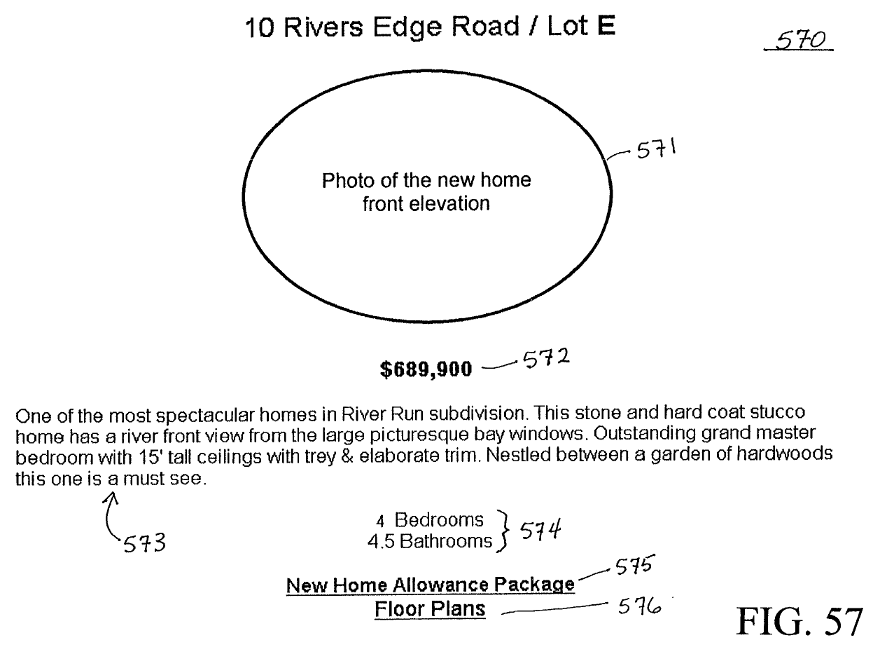

FIG. 53 illustrates a non-limiting example of a Property Selection web page 530 that is presented to a builder that selects the “Detailed Home Info.” option 284 while being presented with a builder web page, such as, for example, the Information Dispersal Control Panel web page 280 (FIG. 28). The Property Selection web page 530 allows a builder to select a home for which the builder wishes to construct a marketing web page, such as, for example, marketing page 570 (FIG. 57) that can be accessed by prospective home purchasers. Once a builder selects a home via the address selection field 531, he can select the “proceed” option 532 to access a web page for entering information about the selected home.

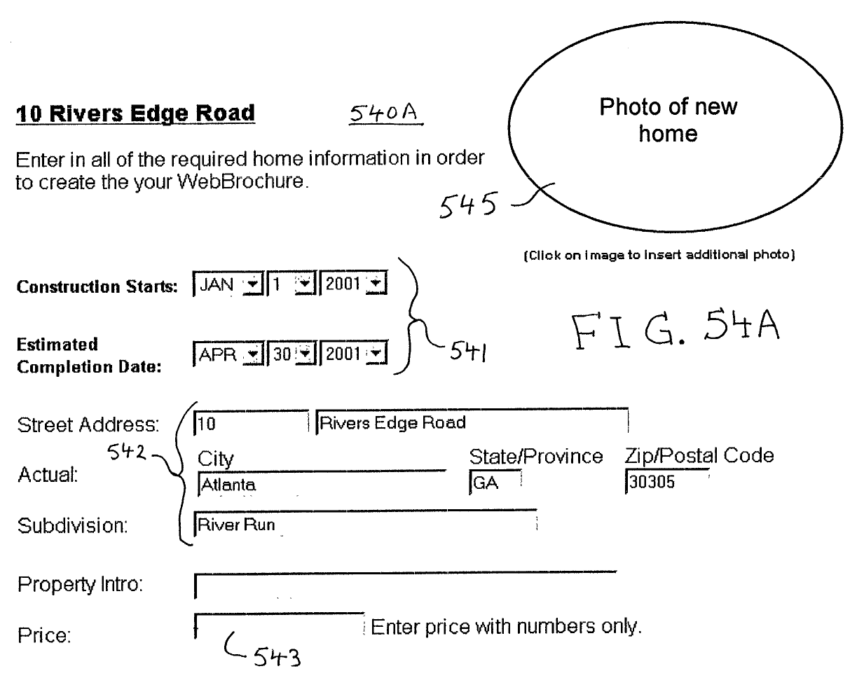

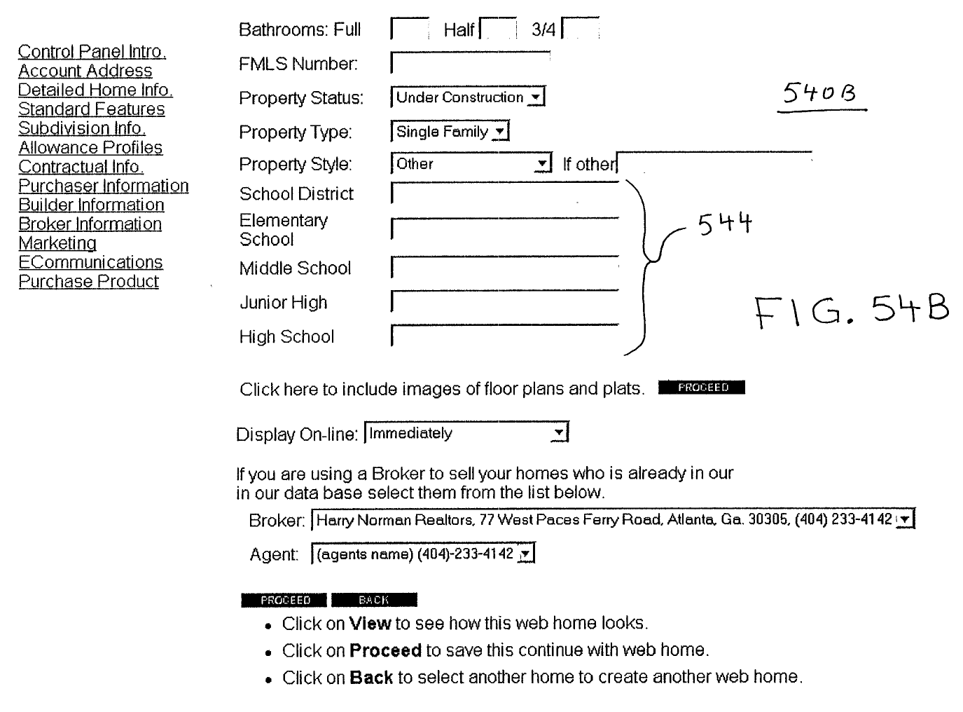

FIG. 54A illustrates a non-limiting example of a Web-Brochure Construction web page 540A that is presented to a builder that selects the “proceed” option 532 while being presented with the Property Selection web page 530 (FIG. 53). The Web-Brochure Construction web pages 540A and 540B allow a builder to construct a marketing web page that can be accessed by prospective purchasers that may be interested in purchasing one of the homes that the builder is or will be constructing. A builder can enter dates for the beginning and ending of construction, information about the location of the home, and the asking price for the home in information entry areas 541, 542, and 543, respectively. A builder may also click on a current image of a home 545 in order to access a web page for entering additional pictures of the home.

FIG. 54B illustrates a non-limiting example of a Web-Brochure Construction web page 540B that is a scrolled down version of the Web-Brochure Construction web page 540A and that is presented to a builder that “scrolls down” while being presented with the a Web-Brochure Construction web page 540A (FIG. 54A). The Web-Brochure Construction web page 540B allows a builder to enter additional information about the home. For example, the builder may enter information about schools located near the home via the school information entry fields 544.

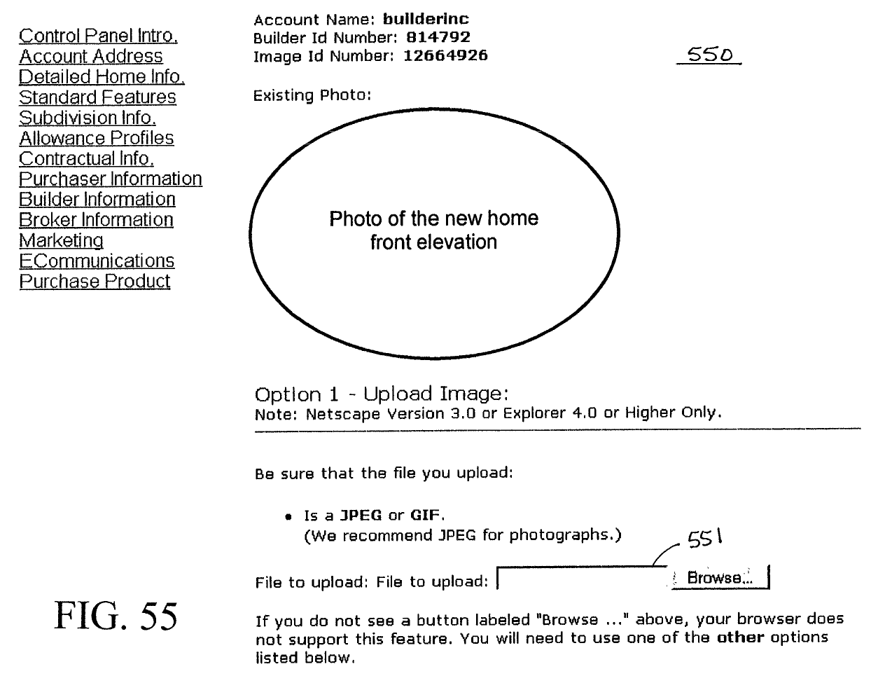

FIG. 55 illustrates a non-limiting example of an Image Upload web page 550 that is presented to a builder that selects the current image of the home 545 while being presented with the Web-Brochure Construction web page 540A (FIG. 54A). The Image Upload web page 550 allows a builder to make one or more additional images accessible via the home marketing web page 570 (FIG. 57). For example, a builder can upload sample exterior home pictures, sample interior home pictures, or floor plans. A builder can upload an image by identifying it in the upload field 551 and by then selecting a “proceed” option (not shown).

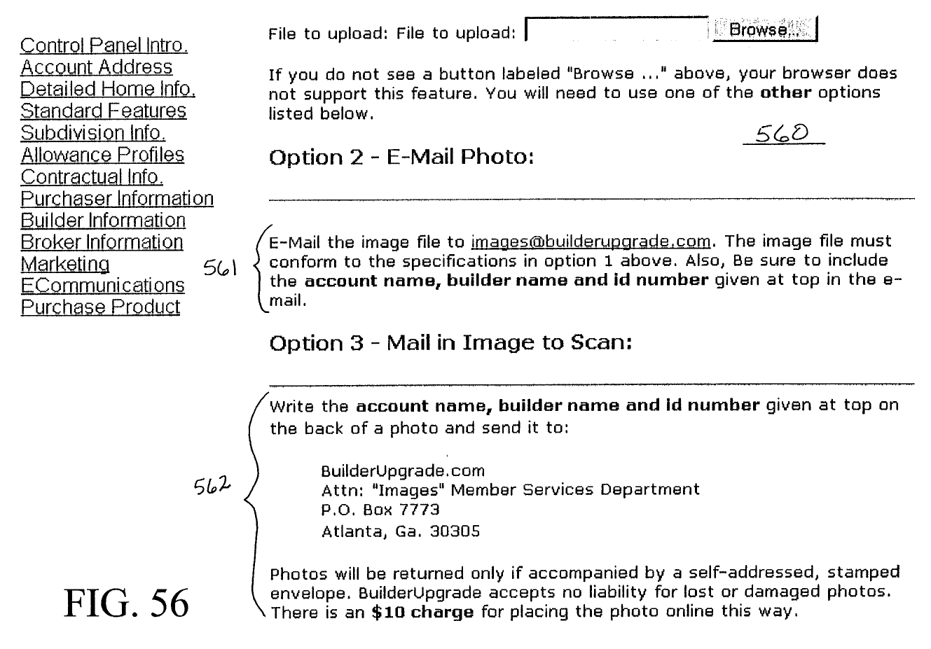

FIG. 56 illustrates a non-limiting example of an Image Upload web page 560 that is a scrolled down version of the Image Upload web page 550 and that is presented to a builder that “scrolls down” while being presented with the Image Upload web page 550 (FIG. 55). The Image Upload web page 560 contains information about alternative methods for making additional images accessible via the home marketing web page 570 (FIG. 57); information area 561 contains information about e-mailing an image to an RCPM e-mail address and information area 562 contains information about mailing a picture to an RCPM physical address.

FIG. 57 illustrates a non-limiting example of a Home Marketing web page 570 that is constructed by a builder using one or more construction web pages, such as, for example, Web-Brochure Construction web page 540A. The Home Marketing web page 570 would be available to prospective purchasers and others via the internet and contains information about the home that is being or will be constructed by the builder. In this example, web page 570 includes an image of the projected appearance of the home 571, an asking price 572, a home description 573, the number of bedrooms and bathrooms 574, a hyperlink to information about the new home allowance package 575, and a hyperlink to floor plans 576.

In one embodiment, in addition to providing services to builders, home purchasers, and merchants, the RCPM system 11 also provides services to real estate agents. For example, a real estate agent representing a builder can use the RCPM system 11 to create a home marketing web page such as, for example, Home Marketing web page 570, or to create real estate contracts for a new home. A real estate contract may either be a real estate sale and purchase contract or an amendment thereto. An example of a contract amendment is one that identifies the obligations of a builder and home purchaser in connection with the home allowances and specific product upgrades and/or product selections made by the home purchaser. The RCPM system 11 can provide copies of detailed contracts based on information that a home purchaser and/or builder submitted to the RCPM system 11. Therefore, by using the RCPM system 11, a real estate agent is less likely to leave out important information from a contract agreement.

### DEFINITIONS

The following are definitions of terms used in this document:

a) a builder: as used herein, a builder is any individual or entity that is in the business of constructing homes, or any employee, agent, or representative of such individual or entity.

b) a home: as used herein, a home is any residential structure, such as, for example, a house, an apartment, an apartment building, a condominium, a villa, or a mansion.

c) a merchant: as used herein, a merchant is any individual or entity that is in the business of selling products used in constructing homes, or any employee, agent, or representative of such individual or entity.

d) a product: as used herein, a product is any item or group of items that is/are used in constructing a home; examples of products include: a home appliance, a lighting fixture, a flooring material, carpeting, a landscaping item, a plumbing item, a counter top, tiles, a cabinet, framing material, marble, paint, wallpaper, interior trim, and exterior facade material.

e) a home purchaser: as used herein, a home purchaser is any individual or entity that has either signed a contract and/or placed a money deposit in connection with the purchase of a home, or any employee, agent, or representative of such individual or entity.

It should be emphasized that the above-described embodiments of the present invention, particularly, any “preferred” embodiments, are merely possible examples of implementations, merely setting forth a clear understanding of the principles of the invention. Many variations and modifications may be made to the above-described embodiments of the invention without departing substantially from the principles of the invention. All such modifications and variations are intended to be included herein within the scope of this disclosure and the present invention and protected by the following claims.

I claim:

1. A computerized method for determining products to be used in building a home, comprising:
maintaining a database identifying products to be used in building homes;
receiving input from a first user identifying a first product to be used in building a home;
receiving input from a home purchaser identifying an alternative product to be used in building said home, said alternative product to be used instead of said first product in building said home; and
providing said first user with access to data identifying said alternative product.

2. The method of claim 1, further comprising:
providing a merchant with data identifying said alternative product.

3. The method of claim 1, wherein said first user is a builder.

4. The method of claim 1, wherein said first user acts on behalf of a builder.

5. The method of claim 1, wherein said first user acts on behalf of a construction company.

6. The method of claim 1, wherein said home purchaser has signed a contract for the purchase of said home.

7. The method of claim 1, wherein said home purchaser has paid a deposit in connection with the purchase of said home.

8. The method of claim 1, wherein a type of said first product is from a group consisting of:
home appliance, lighting fixture, flooring material, carpeting, landscaping item, plumbing item, counter top, tile, cabinet, framing material, marble, paint, wallpaper, interior trim, and exterior facade.

9. The method of claim 1, wherein a type of said home is from a group consisting of: a house, a condominium, an apartment, a villa, and a mansion.

10. The method of claim 1, wherein said input from said first user and said input from said home purchaser are received via the internet.

11. The method of claim 1, wherein said first product is part of a home allowance and said alternative product is an upgrade.

12. A computerized method for determining products to be used in building a home, comprising:
receiving input from a first user identifying a requirement for a product to be used in building a home;
receiving input from a home purchaser identifying a product that meets said requirement; and
providing said first user with access to data identifying said product identified by said home purchaser.

13. The method of claim 12, wherein a type of said product is from a group consisting of:
home appliance, lighting fixture, flooring material, carpeting, landscaping item, plumbing item, counter top, tile, cabinet, framing material, marble, paint, wallpaper, interior trim, and exterior facade.

14. The method of claim 12, wherein said input from said first user and said input from said home purchaser are received via the internet.

15. A system for determining products to be used in building a home, comprising:
logic configured to cause data identifying a first product selected by a first user to be stored in memory;
logic configured to cause data identifying an alternative product selected by a home purchaser to be stored in memory, said alternative product to be used instead of said first product in building said home; and
logic configured to provide said first user with access to data identifying said alternative product.

16. The system of claim 15, wherein a type of said first product is from a group consisting of:
home appliance, lighting fixture, flooring material, carpeting, landscaping item, plumbing item, counter top, tile, cabinet, framing material, marble, paint, wallpaper, interior trim, and exterior facade.

17. The system of claim 15, wherein said first user acts on behalf of a builder.

18. The system of claim 15, wherein said first product is part of a home allowance and said alternative product is an upgrade.

19. A system for determining products to be used in building a home, comprising:
logic configured to cause input received from a first user identifying a requirement for a product to be stored in memory;
logic configured to cause input received from a home purchaser identifying a product that meets said requirement to be stored in memory; and
logic configured to provide said first user with access to data identifying said product identified by said home purchaser.

20. The system of claim 19, wherein a type of said product is from a group consisting of:
home appliance, lighting fixture, flooring material, carpeting, landscaping item, plumbing item, counter top, tile, cabinet, framing material, marble, paint, wallpaper, interior trim, and exterior facade.

21. The system of claim 19, wherein said first user acts on behalf of a builder.

22. A computer readable medium having computer-executable instructions for performing a method comprising:
receiving input from a first user identifying a first product to be used in building a home;
receiving input from a home purchaser identifying an alternative product to be used in building said home, said alternative product to be used instead of said first product in building said home; and
providing said first user with access to data identifying said alternative product.

23. The computer readable medium of claim 22, wherein a type of said first product is from a group consisting of:
home appliance, lighting fixture, flooring material, carpeting, landscaping item, plumbing item, counter top, tile, cabinet, framing material, marble, paint, wallpaper, interior trim, and exterior facade.

24. The computer readable medium of claim 22, wherein said input from said first user and said input from said home purchaser are received via the internet.

25. The computer readable medium of claim 22, wherein said first product is part of a home allowance and said alternative product is an upgrade.

26. A computer readable medium having computer-executable instructions for performing a method comprising:
receiving input from a first user identifying a requirement for a product to be used in building a home;
receiving input from a home purchaser identifying a product that meets said requirement; and
providing said first user with access to data identifying said product identified by said home purchaser.

27. The computer readable medium of claim 26, wherein a type of said product is from a group consisting of:
home appliance, lighting fixture, flooring material, carpeting, landscaping item, plumbing item, counter top, tile, cabinet, framing material, marble, paint, wallpaper, interior trim, and exterior facade.

28. The computer readable medium of claim 26, wherein said input from said first user and said input from said home purchaser are received via the internet.

29. A computerized method for determining products to be used in building a home, comprising:
maintaining a database identifying products to be used in building homes;
receiving input from a first user identifying a first product to be used in building a home;
receiving input from a second user identifying an alternative product to be used in building said home, said alternative product to be used instead of said first product in building said home; and
providing a third user with access to data identifying said alternative product.

30. The method of claim 29, wherein said first user is a builder, said second user is a home purchaser, and said third user is a merchant.

31. The method of claim 29, wherein said first user acts on behalf of a builder, said second user acts on behalf of a home purchaser, and said third user acts on behalf of a merchant.

32. The method of claim 31, wherein at least one of said users acts on behalf of said one of said users.

33. A computerized method for determining products to be used in building a home, comprising:
receiving input from a first user identifying a requirement for a product to be used in building a home;
receiving input from a second user identifying a product that meets said requirement; and
providing a third user with data identifying said product identified by said second user.

34. The method of claim 33, wherein said first user acts on behalf of a builder, said second user acts on behalf of a home purchaser, and said third user acts on behalf of a merchant.

35. A system for determining products to be used in building a home, comprising:
logic configured to cause data identifying a first product selected by a first user to be stored in memory;
logic configured to cause data identifying an alternative product selected by a second user to be stored in memory, said alternative product to be used instead of said first product in building said home; and
logic configured to provide a third user with data identifying said alternative product.

36. The system of claim 35, wherein said first user acts on behalf of a builder, said second user acts on behalf of a home purchaser, and said third user acts on behalf of a merchant.

37. A system for determining products to be used in building a home, comprising:
logic configured to cause input received from a first user identifying a requirement for a product to be stored in memory;
logic configured to cause input received from a second user identifying a product that meets said requirement to be stored in memory; and
logic configured to provide a third user with data identifying said product identified by said second user.

38. The system of claim 37, wherein said first user acts on behalf of a builder, said second user acts on behalf of a home purchaser, and said third user acts on behalf of a merchant.

39. A computer readable medium having computer-executable instructions for performing a method comprising:
receiving input from a first user identifying a first product to be used in building a home;
receiving input from a second user identifying an alternative product to be used in building said home, said alternative product to be used instead of said first product in building said home; and
providing a third user with data identifying said alternative product.

40. The computer readable medium of claim 39, further comprising:
providing said first user with access to data identifying said product identified by said second user.

41. A computer readable medium having computer-executable instructions for performing a method comprising:
receiving input from a first user identifying a requirement for a product to be used in building a home;
receiving input from a second user identifying a product that meets said requirement; and
providing a third user with data identifying said product identified by said second user.

42. The computer readable medium of claim 41, further comprising:
providing said first user with access to data identifying said product identified by said second user.

43. A computerized method for determining products to be used in building a home, comprising:
receiving data from a builder containing information about an asking price for a new home, wherein construction of said new home has not yet been completed;
receiving data from said builder containing information about a new home allowance for said new home;
providing data to a prospective home purchaser containing said information about said asking price; and
providing data to said prospective home purchaser containing said information about said new home allowance.

44. The system of claim 43, wherein construction of said new home has not yet begun.
